(19) United States
(12) Patent Application Publication
(10) Pub. No.: US 2011/0093515 A1
(43) Pub. Date: Apr. 21, 2011

(54) MOBILE LOCAL SEARCH PLATFORM

(76) Inventor: Mary Elizabeth Albanese, Marblehead, MA (US)

(21) Appl. No.: 12/905,725

(22) Filed: Oct. 15, 2010

Related U.S. Application Data
(60) Provisional application No. 61/251,803, filed on Oct. 15, 2009.

(51) Int. Cl. G06F 17/30

(52) U.S. Cl. 707/812; 707/E17.005

(57) ABSTRACT

In embodiments of the present invention improved capabilities are described for a method comprising hierarchically structuring geographic locations to attach and deliver content to individuals near the geographic locations through a web-based search facility, wherein the geographic locations have data associated with them; storing the geographic locations with their associated data as points of interest (poi) in a poi database; and claiming ownership of the poi by an entity associated with the poi, via an Internet web application and whereby an entry in the poi database is marked as being owned by that entity.

### CROSS-REFERENCE TO RELATED APPLICATIONS

This application claims the benefit of the following provisional application, which is hereby incorporated by reference in its entirety: U.S. Application No. 61/251,803, filed Oct. 15, 2009.

### BACKGROUND

1. Field:

The present invention is related to web-based local searching, and more specifically to content delivery to users of mobile devices performing web-based local searching.

2. Description of the Related Art

Consumers today are an educated and savvy group. They know what they want, and with their busy lives they don't have much time to waste. Business owners are constantly trying to attract new customers, promote loyalty, and increase sales. They use a variety of advertising methods like newspaper ads, mailers, loyalty and gift cards, and the like, all with the goal of finding new customers and driving sales. However, these traditional methods have been costing more and more and returning less and less. In addition, many require giving out paper coupons or a plastic card that overwhelms the customer and creates the hassle of bringing the item to their business, which stops many customers from using them. Therefore there is a need for improved methods and systems for providing consumers with content associated with market offerings.

### SUMMARY

The present invention may present the consumer with a single mobile interface to communicate to all the businesses in their life, and though this interface, business owners may concentrate on attracting new customers and delivering marketing incentives. They may avoid the complexity of implementing a mobile platform for storage and redemption and then marketing that mobile platform. By using a single portal, traditional brick-and-mortar companies may harness the power of the mobile Internet to increase sales and create customer loyalty.

The present invention may provide a method to hierarchically structure geographic locations as a means to attach and deliver content to individuals near those locations. The geographic locations may have data associated with them. We will refer to these geographic locations and may be referred to in association with data as points of interest or “pois” and the database that contains these pois, as the “poi database”. In embodiments, the data associated with the geographic location may be an object with specific fields. There may be multiple ‘types’ of these objects stored in the pois database. One such type may be a “destination” object which stores information about consumer businesses such as the name, address, phone number, website, latitude, longitude, credit cards accepted, hours of operation, and the like, of geographic locations that are normally considered destinations for consumers. These destinations may include commercial entities as well as government, historical, scenic, and the like. The pois of object type destination may be initially obtained from multiple third party sources, such as yellow page aggregators, and placed in the pois database. An entity (e.g. a business with multiple stores) which may represent one or multiple pois may claim those pois as there own, such as via a web form on an internet web application herein known as the “web application” and where those entries in the pois database are marked as being owned solely by that entity and can be owned by none other. The set of claimed pois is referred to as “claimed pois”. Note that the term “business” is synonymous herein with the term entity, without losing the implied generality of the term entity. The term “owner” refers to the user of the web application that is ordinarily the business owner. In embodiments, the entity that represents multiple pois may effectively hierarchically group their claimed pois. The groups may be any subset of the claimed pois. The groupings may be named for identification purposes. There is a group called “franchise” that may include all the claimed pois. This grouping may be at the top of the hierarchy. The term used herein for all of a business's groupings is “Claimed pois hierarchy”. In embodiments, once the Claimed pois hierarchy has been identified, content in the form of web pages may be attached to different groups, thus allowing distribution of content to consumers based on geographic and any other constraint(s) that they use in order to perform the grouping. The poi database may be added to if the entity does not find their location listed in the database. After adding their location as a poi, the poi can then be claimed. The poi database may be reduced if the entity wishes to remove a poi that they have previously claimed from it. The content, such as included in a webpage, may be extended to any type of content such as texts, email, voicemail, and the like. The term webpage and url are herein used to mean the content and the pointer to the content respectively. These terms may be swapped instead for the terms text/phone number or email/email address. In order to deliver the content that is attached to a group, the attachments may need to be expanded from being connected to the group into attachments that are connected to individual pois so that search functions can find the content and statistics can be applied to the content delivered for each poi. For example, as soon as webpage is attached to a specific group of pois, a list may need to be made by expanding the group into its individual pois and attaching the content to each poi in the list. In embodiments, expanding may enable the search for the correct content (e.g. webpage(s)) based on searchers geographic position matching at least the position of the poi. Expanding may enable keeping content delivery statistics for each of the specific pois that the content is attached to in the expanded list. The delivery statistics of the content (e.g. webpage) may include, but not limited to “view date”, “last viewed”, “click-through count” (the latter being restricted to webpage content, not text, email), and the like. In embodiments, an additional, identically structured list may need to be kept to preserve the historic statistics. This list may need to be separate from the live list that is used in the search to return the correct webpage(s) because attachments can become stale based on the tagobject (forward reference) that contains the attachment. Although stale, the delivery history may need to be retained for reporting and analysis. The hierarchical structure of the claimed pois hierarchy may be employed to report delivery statistics such as “view date”, “last viewed”, “click-through count”. Because content is attached by grouping, but delivered individually, reporting may be done for both the individual statistics, and also aggregated in terms of groupings.

The present invention may provide for a method where webpages are tagged using objects instead of text fields. The term tagobject may refer to an object that gets related to a url, allowing search engines and other tools to select the url based on a function that acts on the related tagobject or tagobjects. The function that acts on the tagobject may be referred to as the “searchFunction”. In embodiments, one property of the tagobject may need to be the url that it is being related to. The other properties of the tagobject may consist of additional data that the search function can use to find a match. The parameters of the searchFunction plus the logic of the searchFunction may be used to calculate whether there is a match to the properties of any tagobjects. In embodiments, a specific tagobject may be defined with a corresponding searchFunction that allows searching for urls tagged by this tagobject, such as the tagobject has a delivery date property identifying the date range as to when the web page is allowed to be delivered; the tagobject has attachment points property that identifies which groups it wants to be connected to in the “claimed pois hierarchy”; the parameter to the searchFunction is an array of pois; the searchFunction determines if the current date falls within the tagobjects delivery dates property; the searchFunction determines if the array of pois contains any poi that is a member of any poi group that is identified by the attachment points property of the tagobject; and the like. If both of the determinations is true the searchFunction may return the list of matching urls and the poi that is the member. The term used to refer to this tagobject may be a “Jingle Tag”. In this instance, the list of matching urls/business id returned by the Jingles searchFunction may be formatted as links in a webpage and referred to as the Jingles. A single link on the page may be referred to as a Jingle. A specific tagobject may be defined with a corresponding searchFunction that allows searching for urls tagged by this tagobject, such as the tagobject has a delivery dates property identifying the date range as to when the web page is allowed to be delivered; the tagobject has attachment points property that identifies which groups it wants to be connected to in the “claimed pois hierarchy”; the parameter to the searchFunction is radius, latitude, longitude representing the position of the searcher and the distance from their position in which it is acceptable to return search results; the searchFunction determines if the current date falls within the tagobjects delivery dates property; the searchFunction determines its parameters latitude, longitude are within parameter radius of the latitude and longitude of any poi that is a member of any poi group that is identified by the attachment points property of the tagobject; and the like. If both of the determinations is true the searchFunction may return the list of matching urls and the poi that is the member. The term used to refer to this tagobject may be referred to as an “Ad Tag”. In this instance, the list of matching urls/pois returned by the Ads searchFunction may be formatted as links in a webpage and referred to as the Ads. A single link on the page may be referred to as an Ad. A mechanism may be provided to allow a business to easily create a Jingle Tag or Ad Tag using standard web forms.

The present invention may be based on a consumer's geographical position and a filter specified by the consumer, and where a location aware search is performed that accesses the pois database and displays the pois nearest to the consumer that matches the specified filter. The information displayed may depend on the object type of the poi (e.g. destination type would show name, address, phone number, website of a store whereas individual type could show photo, Facebook page, message board). The consumer is able to “save” a pointer to any of the pois displayed to automatically “opt-in” to the marketing program of the business that claimed that poi. The term used to refer to the “saving” of the pointer to one or more of a business entities poi(s) may be referred to as “Bookmarking” the business (not to be confused with browser bookmarking), where what's being saved is a pointer to the database entry that stores the business data like position, address, phone, and the like. In embodiments, the location aware search and Bookmarking capability may reside in an application that can be downloaded to a mobile device, run via a mobile browser, or laptop or other browser, and the like. Herein, this will be referred to as the “mobile application” and the user of the mobile application referred to as the “consumer”. In embodiments, after Bookmarking, content may be pushed to the consumer that the consumer can choose to view at their convenience through the mobile application. Content may only be pushed from Bookmarked entities. The content that is pushed may be Jingles. The request to view the pushed Jingles may be made by the mobile application upon selection of a button by the consumer. The mobile application may call the Jingles searchFunction passing an array of the consumers Bookmarks as the parameter of the function. The mobile application may only provide the ability for the consumer to access Jingles for those entities that the consumer has Bookmarked. An optionally audible jingle may be sounded by the mobile application to the consumer to tell them new Jingles are available. The consumer may also optionally request to be informed via texted, emailed, and the like, when new Jingles are available. The mobile application may request to view Ads upon selection of a button by the consumer. The mobile application may call the Ads searchFunction passing the consumers geographical position and a modifiable (e.g. by the consumer) value for the radius as parameters of the function. The mobile application may save content (a url) to a database and intelligently associate it to the business that created the content. The method may be referred to as “Grabbing”. This action may be initiated upon selection by the consumer. The url saved could be a Jingle, Ad, or any other webpage visible to the consumer within the mobile application. The Grab may be initiated by the consumer by selecting a button in the mobile application toolbar. The mobile application may initiate the display of webpages by viewing the website of a poi that is displayed, viewing a Jingle sent by the business, viewing an Ad sent by the business, and the like. By initiating in one of these ways, the mobile application may intelligently know the poi that the webpage is associated with. A Jingle, Ad link, and the like, on the page may include a function call that is called before redirection to the link, in which the function call intelligently saves the poi value in the state of the mobile application, to enable a future “Grab” to be associated to the correct business that has claimed that poi. The mobile application may provide the ability for the consumer to Grab webpages initiated by the mobile application including pages navigated to from one of the initial pages. The poi that is associated with the Grab may be automatically Bookmarked thus opting-in the consumer whenever they Grab content from the business. The consumer may override the intelligent association of a Grab to the business that claimed the poi and provide their own custom association to a different business. The Bookmarks and Grabs may be stored in the database. The display may be based on any number of fields including but not limited to business name, business location, category that the business is a member of, such as grocery, shopping, eating, transportation, entertainment, nightlife, active life, auto & boat, beauty & spa, pets, living, education, financial, religious, services, government & legal, medical, and the like.

The present invention may provide for a method to create a dynamic JavaScript widget that provides a means to insert retail functionality into a third-party web page, which is directly related to the content of the page. Retail functionality may include providing the ability for a consumer to redeem the webpage at the business's location by transferring the upc or other type of identifying code into the point of sale system; providing the ability to limit the use of the webpage by the consumer; providing the ability to count the number of visits by the consumer for “buy 10 get one free” incentive functionality; providing tracking of the number of times the webpage has been redeemed; providing tracking of the number of times the webpage has been Grabbed; and the like. In embodiments, the widget may contain data, such as item Id (e.g. url that the widget is contained in), start date, end date, dynamic data, upc code, series start, series end, refill series start, refill series end, is interactive, limit per customer, number of visits, and the like. In embodiments, the widget may be expanded to include more data to introduce different types of incentive programs. The business may manually embed a link pointer to the widget into a webpage, giving that page retail functionality. The term for a webpage with the embedded link to the widget may be a retail webpage. The widget upon first being loaded by a browser may execute a registration facility to write its own url back into its data. This may better ensure that the widget data knows the url its embedded in. The webpage in which the widget is embedded may have access to all of the data fields of the widget and may display them. This may be accomplished by pushing the data into the page, such as using the domain of the third-party webpage. The redemption of the retail webpage may be initiated by the consumer selecting a button in the mobile application toolbar. The redemption may be manifested by displaying the upc code (or other identifying code) when the consumer selects the redemption option. For example, this may force the cashier to manually transfer it into the point of sale via the keyboard. Alternately, the redemption may be manifested by transferring the code wirelessly from the mobile phone into the point of sale hardware when the consumer selects the redemption option. The transfer may be executed over Bluetooth, WiFi protocol, and the like, such as using a zero-configuration mechanism to discover the cash register. The point of sale hardware may need to be running software to expedite the transfer. The cashier may be able to accept incoming transfers and the consumer is able to select outgoing cash register. Mechanisms may exist so that errors in transferring can be corrected by retransferring. Selecting the redemption button may automatically cause a Grab of the retail webpage that the redemption button resides in. The widget may be completely functional regardless of whether the retail webpage is being viewed within the confines of the mobile application. For example, if it is being viewed inside of a mobile web browser, it is completely functional, however, login/registration may have to take place before the functionality is properly realized. The widget may provide login/registration functionality so that it can be accessible from any browser, thus allowing the webpage to be distributed in any of a number of ways. The button used to initiate the Grab that is resident in the mobile application toolbar may alternately be placed directly inside the widget embedded in the retail webpage if the retail webpage is being viewed without the use of the mobile application. For example, if it is being viewed inside of a mobile web browser, then the Grab button will be displayed. This may provide more functionality of the mobile application without actually running the mobile application. However, login/registration may have to take place before the Grab is used by the consumer. The mobile application may track the number of times a retail webpage has been GRABBED and the number of times it has been viewed. The mobile application may keep statistics on the number of times redemption occurred. The widget may provide for dynamic upc code generation, allowing each consumer to have a unique upc code per retail webpage.

The present invention may provide a method to create generic mobile surveys and associate them to a business based on the business's category (e.g. restaurant, clothing, salon, and the like). Then to further allow a customized mobile survey to be created by the business and attached to the Claimed pois hierarchy so that depending on the geographical location of the consumer and the groupings, a specific survey will be seen. This may allow an owner to survey differently at one store than another, survey differently at one region or at another, and the like. A portion of a survey may be shown to allow less input from the consumer, thus engaging more mobile consumers. There may exist the ability to distribute a retail webpage reward to a consumer upon filling out the survey. Reporting of survey results may allow the consumer to see options of a large statistical sample matched to the hierarchical structure of the claimed pois hierarchy. In embodiments, people may be considered geographical entities. Every person registered to the mobile application may be considered a poi and automatically saved as an entry in the pois database. The entry in the database may be automatically claimed and owned by the person. In embodiments, the object type of that poi is individual and has different fields than the destination type. Individual type may have a website field possibly pointing to their social networking site, plus name, address, phone, photo fields, and the like. These may be fields common to all individuals. A poi representing the person may have geographic information when the person is running the mobile application. The mobile application may be running in the background, allowing the person to have continuous geographic presence via their poi. The person may disable the visibility of their poi. To add more information to an individual type poi and search on those fields, a tagobject/search function may be specified. This may be identical to the destination type, however the claimant of the individual poi may be the person who the poi represents. This may morph the individual into an employee of an organization by tagging the poi with information that is specific to an employee like job title, job history, current project, interests, social networking business page (e.g. Linked-In), and the like. This may allow for rapid search of a type of person who is at a certain business event, like a conference. The difference between a person as a poi and a store as a poi may be that the persons position is dynamic, where the mobile application keeps that position updated in the pois database. The mobile application may provides an indication that allows the consumer to select whether they are viewing destination pois or individual pois.

These and other systems, methods, objects, features, and advantages of the present invention will be apparent to those skilled in the art from the following detailed description of the preferred embodiment and the drawings. All documents mentioned herein are hereby incorporated in their entirety by reference.

### BRIEF DESCRIPTION OF THE FIGURES

The invention and the following detailed description of certain embodiments thereof may be understood by reference to the following figures:

FIG. 1 depicts an embodiment block diagram of the present invention.

FIG. 2a depicts an embodiment of a user interface for a mobile application of the present invention, showing an icon-logo mode view.

FIG. 2b depicts an embodiment of a user interface for a mobile application of the present invention, showing a text-logo mode view.

FIG. 2c depicts an embodiment of a user interface for a mobile application of the present invention, showing a search view.

FIG. 2d depicts an embodiment of a user interface for a mobile application of the present invention, showing a search view with restaurant group expanded.

FIG. 2e depicts an embodiment of a user interface for a mobile application of the present invention, showing an items view with topic headings.

FIG. 2f depicts an embodiment of a user interface for a mobile application of the present invention, showing a text-logo mode view with a representative coupon.

While the invention has been described in connection with certain preferred embodiments, other embodiments would be understood by one of ordinary skill in the art and are encompassed herein.

All documents referenced herein are hereby incorporated by reference.

### DETAILED DESCRIPTION

The present invention may provide a consumer with market offerings through their mobile application device (e.g. their mobile phone) that are both more convenient for the consumer and more efficient for businesses. In an embodiment of the invention, when a customer walks down a particular street, the mobile application may display businesses on that street. If the customer sees a particular business of interest, they may click on that business and immediately see the website or mobile website for that business. The customer may then see the promotions, specials, services, and the like provided by that business. The mobile application may provide up to the minute information that may be easily generated and modified by the business by using existing technologies, such as HTML, CSS, JavaScript, and the like. The web application may allow the business to enhance existing webpages by embedding retail functionality in them. For example, a customer may see a loyalty card icon associated with a business and by clicking on (or “Grabbing”) the card icon, the customer may store the loyalty card in a database. In another example, the customer may see a coupon, and Grabbing the coupon icon, the customer may cause it to be stored in a database. Anything the customer “Grabs” may be saved in the database, and further, it may be stored in a folder that is named after the business that created the content or named in some other manner. The next time the customer makes a purchase they may wirelessly redeem a coupon or loyalty card directly into the business' point of sale system. This may occur with no modification to the business's existing point of sale software and with no need for the business to purchase expensive hardware scanners. Further, the mobile application may provide a direct connection from the business to that customer. The mobile application may allow the consumer to bookmark that business on their phone. The consumer may return back to the business to browse its website and Grab more content such as coupons, tickets, loyalty cards and the like. Also, by creating a bookmark for a business, the consumer may be automatically opted-in to the business that may allow the business to push content to the customer. Such content may include redeemable webpages and the like. This may replace sending a mailer to the customer's home, emailing the customer a coupon, texting them an offer, and the like. The mobile application may connect the consumer to the business wherever they are, where paper and plastic cards may not be required to give the customer access to various information of that business.

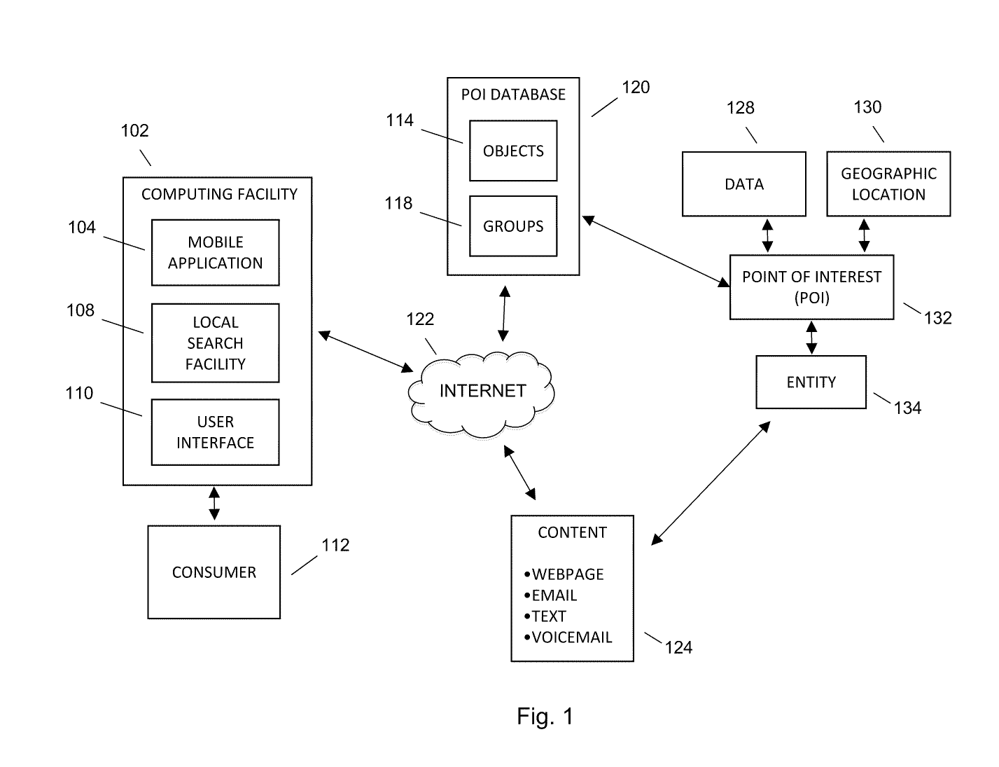

Referring to FIG. 1, in embodiments, the present invention may include a mobile application 104 on a computing facility 102 (e.g. mobile phone, smart phone, PDA, laptop computer, desktop computer, navigation device, and the like), such as with a local search facility 108, user interface 110, and the like, that interfaces with the consumer 112. The computing facility 102 may connect to the internet 122 though wired or wireless connections, where the wireless connection may be any wireless technology known to the arts, such as through the cell phone network, WiFi, Bluetooth, and the like. In embodiments, an entity 134 (e.g. business, or other entity as described herein) may be associated with a point of interest (poi) 132 that may be further associated with a geographic location 130, data 128, and the like, as described herein. Points of interest 132 may be stored in a poi database 120, such as containing objects 114, and grouped, as described herein. In embodiments, the consumer 112, may be able to access content 124 through the Internet connection of their computing facility 102 that may have been provided by the entity 134, and associated though the poi stored in the poi database 120.

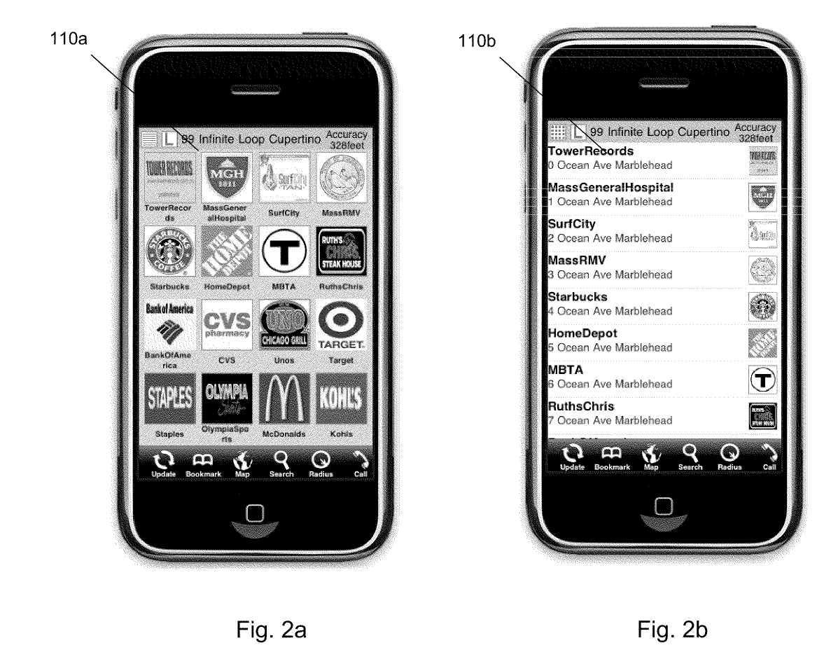

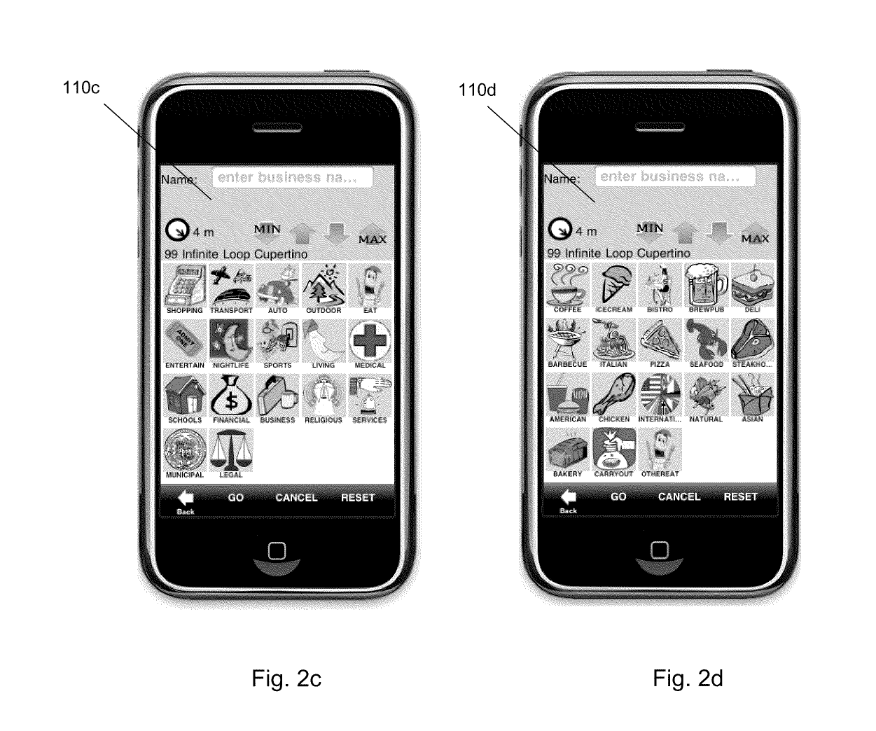

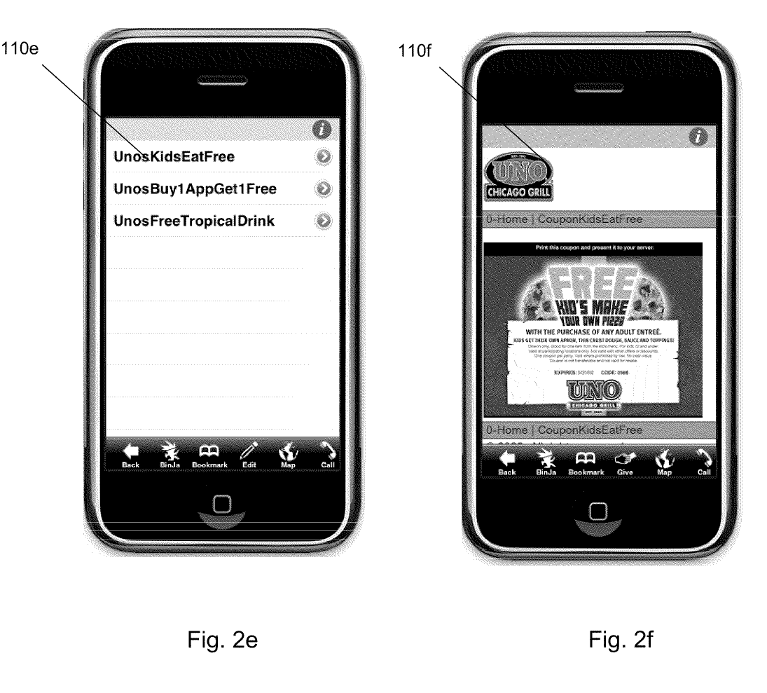

In embodiments, the user interface 110 may be through a mobile computing device, and provide a graphical user interface such as shown in FIGS. 2a-e. For example, FIG. 2a depicts an embodiment representation of a user interface on a mobile phone showing an icon-logo mode view 110a. FIG. 2b shows an embodiment of a text-logo mode view 110b. FIG. 2c shows an embodiment of a search view 110c. FIG. 2d shows an embodiment of a search view with the restaurant group expanded 110d. FIG. 2e shows an embodiment of an items view with topic headings 110e. FIG. 2f shows an embodiment of a text-logo mode view with a representative coupon 110f. These embodiments of the user interface are of a mobile phone and are not meant to be limiting in any way, as the user interface 110 may take many different forms, on different types of computing facilities.

### Terminology:

The following defines terminology as applied herein in the description of the present invention:
mobile application—an application that is either downloaded to the customers phone or it can be run as a web app on a browser. The mobile application delivers location aware content. It provides consumers an innovative communication channel to their favorite businesses.
web application—an application accessed via a web browser. Provides the ability for an entity to own certain geographic locations (known as pois) and distribute content to the mobile application that is in the vicinity of geographic locations. The web applications can enhance existing webpages with retail functionality and channel that content to consumers who are either running the mobile application or come across the content using a browser application. Retail functionality includes the controls to manage and redeem coupons, loyalty cards, gift cards, surveys, tickets, and the like.
webpage—mobile webpage
url—address of webpage
item—an object that represents a url and a teaser that describes the url. In embodiments, the teaser may be less than a predetermined number of characters, such as 64 characters.
widget—dynamic JavaScript that embeds retail functionality into a webpage
retail webpage—a webpage with a widget embedded in it
item manager—a component of the web application for creating retail webpages and for connecting urls (e.g. of normal webpages, retail webpages) to specific search functionality
pois—point of interest geographic location with its associated data
pois database—database that contains pois
poi object type—defines the associated data of a poi
destination type—a specific poi object type, as described herein
individual type—a specific poi object type, as described herein
entity—an organization that represents a poi or multiple pois
business—another term for entity
owner—the person of the business that uses the web application
consumer—the person that uses the mobile application
claiming—the act of identifying a poi as being owned be a specific business
franchise—the default group which encompasses all of the claimed pois of a business
group—a list of pois that is named. The pois may need to have been previously claimed
claimed pois hierarchy—the list of groups that a business organizes their pois in
attach—to connect to a group
attachment points—list of groups to attach to
expanding—the act of replicating a tagobject as many times as necessary to attach it to individual pois instead of to the grouping of those individual pois
statistics—information on the delivery of a webpage and webpage link—viewed count, last viewed, click-through, and the like.
bookmarking—the act of a consumer using the mobile application to save a specific poi to their database. This opts the consumer in to the marketing campaigns of the business that owns that poi.
tagobject—an object representing search criteria that is connected to a url
searchFunction—function that acts on tagobjects to determine if the connected url should be displayed to the consumer
Jingle tagobject—a specific tagobject, as described herein
Ad tagobject—a specific tagobject, as described herein
Jingle searchFunction—a specific searchFunction, as described herein
Ad searchFunction—as specific searchFunction, as described herein
Jingle—a webpage tagged by a Jingle tagobject. It may be delivered to consumers that have opted-in to a business by bookmarking one of its pois. The webpage may only be delivered if it is available within certain dates.
Ad—a webpage tagged by a Jingle tagobject. It is only delivered if consumer's position is near one of the pois that is specified in the tagobject attachment point.
api—group of tagobjects and searchFunctions accessible by any application.

### Background on Local Searching:

The present invention is associated with electronic local searching. A variety of search engines currently provide local search, where some are further targeted to specific vertical segments while others are tied to mapping products. Various geo-location techniques are used to match visitors' queries with information of interest. The sources and types of information and points of interest (pois) vary with the type of local search engine. For instance, map systems look for physical addresses mentioned in regular web pages. It provides these results to visitors, along with business listings and maps. Product-specific search engines use techniques such as targeted web crawling and direct feeds to collect information about products for sale in a specific geographic area. Other local search engines adjunct to major web search portals. Search engines offer local businesses the possibility to upload limited business data to their respective local search databases. Local search companies base their solution on business listings databases developed in-house or licensed from a third-party data publisher.

### Background on Claiming a Business:

Claiming a business may be the first step when a business interfaces to a local search application. When a business claims its geographic location(s) it may present accurate business data to the consumer that finds it in a search. Businesses who would like information such as their name, address, phone number, website, business description, business hours, and the like to appear on local search engines have several options. These options may include: entering a business listing in traditional Yellow Pages and providing listing to electronic Yellow Pages aggregators, search engine optimization services where some search engines may pick up on web pages that contain regular street addresses displayed in machine-readable text (rather than a picture of text, which is more difficult to interpret), and the like. Furthermore, web pages may also use geotagging techniques. A reliable way to include accurate local business information may be to claim business listings through a search engine. An effective way to enter business information into a local search product may be to “claim the business” using the proprietary interface of the local search application. However, “claiming a business” in current systems is an inherently static process. For instance, the business may simply provide or correct static data that represents their business to the associated search portal. That data may then be delivered to the consumer who comes across it either through geo positioning or search techniques. There is no dynamic modification or enhancement of this information. Ordinarily, the types of data that a business can create may be limited to the following: name, address, latitude/longitude, phone number, photos, and web address. The results of a search, either location aware or by text, may display at least the name, address, phone number of the business and at the most a list of photos and a web link. The consumer may get an electronic yellow page directory. Ordinarily, the local search product may also add the ability for consumers to review the business, thus providing additional opinion information to other consumers.

### Claiming a Business:

The present invention provides for a substantial enhancement to the process of “claiming a business”, allow a company with multiple store locations to group these locations together in various ways, and attaching content at different levels of the hierarchy, thus allowing them to distribute content to the consumer that may be based on geographic and/or any other constraint(s) that they prefer in order to perform the grouping.

In embodiments, geographic locations, especially those specific to consumer related businesses, may have data associated with them such as name, address, phone, latitude, longitude and the like. These geographic locations with their associated data may be referred to as points of interest or “pois”. The database that contains these pois may be referred to as the “poi database” or the “database”. The database may reside in the web application. The poi may be implemented as an object with specific fields. There can be different ‘types’ of pois stored in the pois database. One such type may be a “destination” poi that stores information about consumer businesses. For example, if a geographic location is normally considered a destination for consumers, it may have a destination type poi representing it in the poi database. These destinations may include commercial entities as well as government, historical, scenic, and the like. A destination poi may include data as specified above, hours of operation, credit cards accepted, type of business, and the like. Destination pois may be initially obtained from multiple third party sources such as yellow page aggregators and the like and placed in the pois database. Another type of poi is an “individual” poi that stores information about a person, as described herein.

In an example of ‘claiming a business’, a business entity may make up of 50 different store locations. The owner may log into the web application and locate the “Find My Listing” section. The owner may then enter their business name and a list of pois that match that name that will be displayed. If the owner selects a matching listing, a verification code may be sent, such as via United States mail, a phone call, and the like. When the verification code is received, the owner will be able to claim that location. With the verification code, the owner may proceed to claim the location.

When the poi is claimed, it may be grouped with other pois. Any poi that is claimed automatically may become part of a default group named “franchise”. The franchise is the highest level of grouping of a poi. The owner may, after claiming, create additional groupings. The grouping can be geographic, for example, by creating the NORTH, SOUTH, EAST, and WEST groups and placing claimed poi in one of these groups. Additional groupings may be by additional constraints. For instance, creating a SUPERSTORES group or the STORES group, may be created where the user forces every poi into one of the two. Another layer of grouping may be DESIGNER for those stores that provide designer labels, and in that case, only some pois may be placed in that group and there may be no complement group. In this manner, different content may be delivered to the superstores than the smaller store and different content may be sent to stores that deliver designer labels. The number and type of groupings may by unlimited. The groupings may include region, economic levels, store size, and the like. Using the Web Application owner platform, pois may be moved in and out of groups easily. In addition, groups and the businesses franchise may be renamed. This structure is referred to herein as the “Claimed pois hierarchy”.

Once the owner has ownership of pois and has created the Claimed pois hierarchy, the owner may now use the web application to create innovative content and direct it to the consumer. The web application has multiple methods to distribute the content as described herein. In addition, the business owner may control whether the content is attached to individual pois, groups or to the entire franchise. This is a powerful organizational capability that may allow a business to concentrate on the content it is sending and freely apply it to individual locations or groups of locations. This structure may also allow for advanced statistical analysis, which may allow the business owner to see how different content is being received at different grouping.

### Content:

The content delivered to the consumer via the mobile application are mobile web pages. The mobile application may have geo capabilities and an embedded browser that can view standard HTML/JavaScript/CSS web pages. The owner may create the content themselves, and may use the web application to enhance the content to have retail functionality such as coupons, loyalty cards, gift cards, tickets, surveys, branded games, and the like. All of the content may be delivered to the consumer as mobile web pages.

There are a plurality of delivery mechanisms that are used to display webpages to the consumer running the mobile application, including standard web browsing, jingles, ads, surveys, and the like.

Standard web browsing: The mobile application may provide a “nearby” feature in which the consumer's geo-position is sent to the mobile application server and a list of nearby pois is displayed. The consumer may be able to filter the search based on radius, name of business, type of business, general search phrase, and the like. Once the list of pois is presented to the consumer, a single poi may be selected and information about that poi, such as name, address, phone, credit cards accepted, and the like may be displayed in addition to a link to the businesses website. The consumer may select the website link and navigate in the traditional manner to view webpages. The website may or may not be a mobile website depending on what the business has implemented. The mobile application may determine the website link of a business based on various methods including yellow page aggregator data spidering the Internet, and the like.

Jingles: The “nearby” feature of the mobile may present a list of nearby pois to the consumer. The consumer may then “bookmark” one of those pois to “opt-in” to the marketing program of the business that has claimed that poi. Once opted in, webpages may be pushed to the consumer who may choose to view the pages or not. These web pages may represent flyers, coupons, and the like. The concept of Jingles is discussed further herein.

Ads: The consumer can choose to view webpages that usually represent flyers, coupons, and the like, which are attached to the pois near them. The concept of Ads is further discussed herein.

Surveys: The consumer can choose to view webpages that represent Surveys that may be attached to pois nearby them. The concept of Surveys is further discussed herein.

### Tagging Background:

Tagging is known by a few different names, such as content tagging, collaborative tagging, social tagging, folksonomy, and the like. In general tagging can be defined as the practice of creating and managing labels (or “tags”) that categorize content using simple keywords. Content tagging can be broken into two types of tagging schemes, regardless of the exact type of implementation—public tagging and publisher tagging. The first type of tagging, public tagging, creates a situation where visitors to a site can add and manage their own tags for content. In contrast to traditional categorizing and other indexing techniques, public tagging allows visitors to freely choose the keywords that describe content, which means that the consumers of the content are the ones that determine its relevance. A good example of public tagging can be found at some of the social bookmarking sites that have made tagging so popular, such as Digg.com, Del.icio.us, and 9rules.com. In a social bookmarking example, users are able to submit links to online content. When the link is submitted, the user is given the opportunity to associate tags, or a series of keywords, with their submission. Once tagged, other users can then search using these tags to find online content that has been deemed relevant by Internet users, rather than declared relevant by a publisher. This is the true power of tagging, in that it creates another vector for searching and organizing relevant content that is dynamic in nature, and more accurately reflects the opinions of Internet users. Another type of tagging, which will be referred to as “publisher tagging,” is similar except the creator (or “publisher”) of the content is the one that places the tags. Rather than allowing users to freely create and manage tags, the publisher may choose to use tagging to make searching for content easier. As opposed to a social bookmarking site, which simply links to other content on the Internet, the actual content providers often find it more useful to tag their content so users can find relevant content more easily. An example of this is the photo-sharing site Flickr, which allows its users to post and share photos. The person that is sharing the photos can “tag” each one with a series of keywords, and the result is that Flickr users can search for photos based on the tags from the publisher. A tag cloud or word cloud (or weighted list in visual design) is a visual depiction of user-generated tags, or simply the word content of a site, typically used to describe the content of web sites. Tags are usually single words and are normally listed alphabetically, and the importance of a tag is shown with font size or color. Thus, it is possible to find a tag alphabetically and by popularity. The tags are usually hyperlinks that lead to a collection of items that are associated with a tag. Sometimes, further visual properties are manipulated, such as the font color, intensity, or weight. Current location aware search techniques don't use this type of tagging because it involves the participation of the webpage owners to tag their location, products, and offers. Instead, they use complex search algorithms to find pages the consumer would be interested in based on the consumer's position. So, the process of location aware search is (1) a user types in a search phrase and users position is entered either manually or via geo-positioning and (2) the search engine scans billions of pages of content to try to ascertain if the content is local to the user. This is done by matching the search phrase and position to the content scraped from the pages and inferences made.

### Advanced Tagging in an Embodiment of the Invention:

The present invention utilizes a more sophisticated implementation of the tagging concept and utilizes the participation of the webpage owners to tag their offers that are then delivered on demand, or pushed to the consumer. Instead of tagging a page with a word or a phrase, the page is tagged with an informative object to allow much more complex and customized searching. Traditional tagging of a web page implies relating a list of words or phrases (taglist) to a web page that can allow a search engine to compare the words or phrases to the search input to return pages that have tags in their taglist that match. The taglist is related to the url of the webpage via some type of relational table. This basic tagging mechanism is improved by extending the concept of a tag being a text field (word or phrase) to the concept of a tag being an object. In typical use, a tag is a simple text field that gets related to a url, allowing search engines and other tools to select the url based on a basic string comparison to the related tag or tag list. The enhancement is embodied in the terms ‘tagobject” and “searchFunction” in which A tagobject is an object that gets related to a url, allowing search engines and other tools to select the url based on a function that acts on the related tagobject or tagobjects. The function that acts on the tagobject is referred to as the “searchFunction”. One property of the tagobject is always the url that it is being related to. The other properties of the tagobject consist of additional data that the search function can use to find a match. The parameters of the searchFunction plus the logic of the searchFunction are used to calculate whether there is a match to the properties of any tagobjects. A tagobject is much more powerful than a simple tag. A tag object can be any information necessary to identify the url, such as an object that identifies latitude, longitude; an object that identifies a group of locations, for example a list of states, or list of historical monuments; an object that identifies an image or group of images; an object that identifies real estate terms including price, build date, number of bedrooms, number of baths, acreage, location; and the like.

Once a tagobject is identified and related to a url, there is a need for a function that takes that object as input, and then processes the data, then returns a TRUE/FALSE as to whether the url is a match. This function is referred to as the searchFunction.

Tagobjects and searchFunctions:

The web application allows owners to relate tagobjects to mobile web pages so they can be delivered based on a variety of criteria to a mobile consumer. For the sake of clarity, lets give an example. Lets say that the web application has defined only ONE type of tagobject, call it the “geo tagobject”, and that geo tagobject simply stores a longitude and latitude. Lets say that an owners (e.g. business owner) has 50 stores in their franchise, then they will want to create a geo tagobject for every store in their franchise. They then will want to relate those geo tagobjects to various urls so that consumers nearby one location would see a certain url while consumers at another location would see a different url. Of course there is a many-to-many relationship between urls and geo tagobjects because the owners might want multiple url's to be seen at a certain location, or the owners might want multiple locations to see the same url. The geo searchFunction associated with this tagobject type may be as follows:

```
function geotag(input lat, input lon) {
    // in our current example the owner created 50 geotagobjects
    // and they are previously saved in the geotagobjectArray-
    // each one representing the lon/lat of a single store in the franchise
    foreach geotagobject in geotagobjectArray
        if (input lat,input lon is within 1 mile of geotagobject.lat/lon)
then
            foreach url related to geotagobject
                urlArray = url;
        }
        return htmlFormattedListOfLinks(urlArray);
}
```

The list of matching urls returned by the searchFunction is formatted as links in a webpage. The tagObject and the searchFunctions used to search for matching urls are considered a part of an “api” that is accessible from the mobile application or from other third-party applications. This example showed how relating a latitude/longitude tagobject or multiple latitude/longitude tagobjects to a url, effectively “tags” it so that the searchFunction geotag can find it if the consumer is nearby a certain location.

Having the ability to ‘tag’ individual pages based on certain criteria, is a more effective means to search. The search can be quite sophisticated, because it extends beyond simple text matching. This can be used to bring the internet to the mobile phone consumer, instead of having the mobile phone consumer go to the internet by opening a browser and typing in an address or searching. Individual urls can now be sent out to any application that (1) can call the api to make the searchFunction re-question (in the previous example that would be simply calling geotag (input lat, input lon), and (2) is able to display the returned HTML page which is simply a list of the urls that matched the request. Historically browsers were the only applications that were capable of displaying HTML, however, with the recent introduction of chromeless embedded browsers (webkit), it is a simple task to have any application, including any mobile application, to have the capability to display HTML pages. If an application can display mobile HTML pages, it can use the api to request urls based on the tagobjects related to those urls. The mobile application is one such application.

Use Case of tagobjects and searchFunctions: Jingles, Ads, and Surveys

The web application has currently defined three type of tagobjects and their associated searchFunctions—Jingles, Ads, Surveys. The following is a brief description of what webpages (urls) would be related to these three types of tagobjects followed by the details of the tagobject/searchFunctions.

### Jingles:

Jingle tagobject consists of these properties:
   business_id—business that created the object
   attachment_points—what poi groupings this tagobject is connected to
      in the Claimed pois hierarchy
   url—the url that the tagobject is related to
   delivery_start_date
   delivery_end_date
The Jingle searchFunctions are:
   fetchJinglesxpForPoiList(poi_ids[ ],limit)
      the parameter to the searchFunction is an array of pois
      the searchFunction determines if the current date falls within the tagobjects delivery dates property
      the searchFunction determines if the array of pois contains any poi that is a member of any poi group that is identified by the attachment points property of the tagobject.
      If both of the above determinations is true the searchFunction will return the list of matching urls and the poi that is the member
      The list of matching urls/pois returned by the Ads searchFunction is formatted as links in a webpage and referred to as the Ads. A single link on the page is referred to as a Ad.
   fetchJinglesxpForFranchiseList(franchise_ids[ ],limit)
   —similar to above except just for the franchise group

### Ads:

Ad tagobject consists of these properties
   business_id—business that created the object
   attachment_points—what poi groupings this tagobject is connected to
      in the Claimed pois hierarchy
url—the url that the tagobject is related to
   delivery_start_date
   delivery_end_date
The Ad searchFunctions are:
   fetchAdsxpWithinRadius(latitude,longitude,radius,limit)
the parameter to the searchFunction is radius, latitude, longitude representing the position of the searcher and the distance from their position in which it is acceptable to return search results.
the searchFunction determines if the current date falls within the tagobjects delivery dates property
the searchFunction determines its parameters latitude, longitude are within parameter radius of the latitude and longitude of any poi that is a member of any poi group that is identified by the attachment points property of the tagobject.
If both of the above determinations is true the searchFunction will return the list of matching urls and the poi that is the member
The list of matching urls/pois returned by the Ads searchFunction is formatted as links in a webpage and referred to as the Ads. A single link on the page is referred to as an Ad.
The owner creates Jingle, Ad, Survey tagobjects and may do so by using the web application. There may be a simple point-and-click interface for the owners to create them.

### Surveys:

Survey tagobject consists of these properties:
   business_id—business that created the object
   attachment_point—what poi grouping this tagobject is connected to
      in the Claimed pois hierarchy
   url—the url that the tagobject is related to
The Survey searchFunctions are:
   fetchSurveyForPoi(poi_id)
      the parameter to the searchFunction is a poi
      the searchFunction determines if the poi is a member of the poi group that is identified by the attachment point property of the tagobject.
      If the above determination is true the searchFunction will return the matching url
      If multiple tagobjects return a url then the url with the lowest group in the hierarchy will be returned.
      The matching url returned by the Survey searchFunction is then presented as a webpage

Third party applications may access the above listed via the api, allowing them to search for matching urls. (An extension may allow a third-party developer to define their own tagObjects and implement their own searchFunctions to enhance the tagging functionality that is inherent in the web application).

### Example of Creating, Tagging, and Distributing Jingles and Ads

The first thing an owner must do is to create a mobile web page. The web page may be created by the owners using their own web design techniques, simply defined using text (such as accomplished using the item manager) then dynamically generated as HTML on the fly when its time to be delivered, and the like. An owner may choose how to create the web page based on their expertise in web design. A business with advanced Web skills may choose their own web design so that they could have complete control over the display of the page. A business who didn't care about the graphical display and just wanted a webpage that was basic and expressed their message may opt for a text solution. Tagging may be described as a two step process, entering the web page url into the Item manager, and then creating the tagobject, either a Jingle or an Ad for instance, and connecting it to the url. Once the web page is created an owner may identify it to the web application, such as by using the Item manager. The item manager asks for the url of the mobile page and also asks for a title of the page otherwise known as the “teaser” for the url. Note that the web page may be created at this point as a “simply defined using text” webpage. This is so that the creating step can be avoided and is only if the owner wants an extremely simple web page that just has some text describing the item, such as no graphics, no links, and the like. If that is the case, the item manager will specify a url that when selected may generate the simple web page on the fly.

Once the url of the page is entered into the item manager it is now considered to be a “item”. So basically an item may be just a url with an additional piece of “teaser” metadata. So far, this may be considered as a standard implementation for the first step of a classic tag based system, in that the user is required to input the url into the system. It hasn't been tagged yet, the user has just told the system about it.

The next step in a tagging system may be to list all of the textual tags that are related to the item. However, in the present invention, using “text” is not be used to tag the item, instead the next step is to relate a tagobject(s) to it, either a Jingle(s) or an Ad(s) or both. The item then may have one or more “tagobjects” associated with it and the web application can distribute that page based on any api request that calls one of the searchFunctions to match that item.

Once a business owner has created an item (which may be just a webpage plus teaser entered into the item manager) they now relate a tagobject to it. The tagobjects currently implemented are for Jingles and Ads. The business owner has to decide if this is an item that they want to use as generic advertisement to lure new customers in or if its an item that they want to send to their valued customers who already frequent their establishment and have bookmarked their business. Let's assume they decide to targeted their valued customers. They want to create a Jingle tagobject. Each tagobject has its own creation tool, that is part of the web application. For Jingles this creation tool is referred to as the Jingle Manager. Using the Jingle Manager, the owner may fill in the fields of the tagobject, in this case the fields would be the item, delivery dates, the attachment points of the Claimed pois hierarchy. If the owner just wants to send their item to consumers who have bookmarked a particular location, such as Pizza Palace, 1 Elm St, than the owner will select a single poi as an attachment point. If however the owner would like the item to be seen by any consumer who has bookmarked any location in the franchise (Pizza Palace 2 Main St, Pizza Palace 14 Washington St etc) than they can select the franchise group as an attachment point. Multiple attachment points can be specified.

Via the mobile application the consumer may request Jingles, such as by selecting one of two buttons. The first button “Franchise Jingles” may request Jingles only at the franchise level. As an example, they will be requested using api searchFunction

fetchJinglesxpForFranchiseList(franchise_ids[ ],limit)

The second button may request Jingles at the franchise level, plus any group or poi level Jingles that match the pois that the consumer has bookmarked. There are two functions available. As an example, they will be requested using api searchFunction

fetchJinglesxpForPoiList(poi_ids[ ],limit)

In both cases the function may return an HTML page that is a list of links to the webpages that the items point to. The items teaser may be the link text. The poi that caused the match may be embedded as a parameter to a function that is called before the link is redirected to (e.g. the function is implemented as an “onclick”). The purpose of the function is to store the poi in the mobile application state for later use by the Grab, as described herein. In embodiments, there may be a similar way to request Ads, such as via a button in the mobile application. The ads will be requested through a call to api searchFunction

fetchAdsxpWithinRadius(latitude,longitude,radius,limit)

The function may return an HTML page that is a list of links to the webpages that the items point to. The items teaser may be the link text. The poi that caused the matched may be embedded as a parameter to a function that is called before the link is redirected to (e.g. the function is implemented as an “on-click”). The purpose of the function may be to store the poi in the mobile application state for later use by the Grab, as described herein.

### Expansion:

Jingle and Ad tagobjects may have attachment points at different levels of the Claimed pois hierarchy. These attachment points may be created when the owner creates the Jingle or Ad. Although an owner may create just a single Jingle (or Ad), when it's attached to a group, that single Jingle (or Ad) may expand into multiple Jingles, each attached to an individual poi in that group. In embodiments, this expansion may be key to allowing accurate distribution and tracking of the url that is related to the Jingle (or Ad) tagobject. In an example, assume the Acme business (business id=44) has 5 stores and the following Claimed pois hierarchy: five pois in the franchise group 777 whose poiIds are—555,556,557,558,559; and two pois in the “superstores” group 888 whose poiIds are—555,556.

Table 1 shows what a Jingles Table looks like after four different Jingles have been entered by Acme:

TABLE 1

| Jingle | | | | | |
|---|---|---|---|---|---|
| ID | Business ID | Group ID | Poi ID | Item ID | Delivery Dates |
| 33 | 44 | 777 | null | 999 | January-March |
| 34 | 44 | 888 | null | 988 | January-March |
| 35 | 44 | null | 555 | 977 | April-May |
| 36 | 44 | null | 558 | 922 | February-September |

In the above example there are two Jingles attached to a single poi (35 and 36). There are two Jingles attached to groups. Jingle 34 is attached to the “superstores” group and Jingle 33 is attached to the franchise group (777).

In this example, a Merchant modifies the Jingles Table we expand it into a jinglesxp table. The jinglesxp table represents the data in the jingles table, except each group jingle is expanded so that the jingle is replicated for every poi in the group, and statistics fields are added to track the jingle, such as last viewed (e.g. the last time the jingle link was viewed at this location); count (e.g. the number of times this jingle link was viewed), click-through (e.g. the number of times this jingle link was selected to show the jingle webpage; and the like.

Table 2 is what the expanded jingles table, jinglesxp, would look like after four Jingles had been added into the Jingles Table.

TABLE 2

| | | | | | Deliv | | | |
|---|---|---|---|---|---|---|---|---|
| Jinglexp_ID | Jingle_ID | Bus_ID | Poi_ID | Item_ID | Dates | Istvwed | count | clckthr |
| 0 | 33 | 44 | 555 | 999 | January-March | Aug 13 | 2 | null |
| 1 | 33 | 44 | 556 | 999 | January-March | | | |
| 2 | 33 | 44 | 557 | 999 | January-March | | | |
| 3 | 33 | 44 | 558 | 999 | January-March | | | |
| 4 | 33 | 44 | 559 | 999 | January-March | | | |
| 5 | 34 | 44 | 555 | 988 | January-March | | | |
| 6 | 34 | 44 | 556 | 988 | April-May | | | |
| 7 | 35 | 44 | 555 | 977 | February-September | | | |
| 8 | 36 | 44 | 558 | 922 | | | | |

However, before the expand we first save the old jinglesxp into a jingleHistory table. In embodiments, the jingleHistory table has the exact same fields as the jinglesxp. To do the save, we must first MERGE the jinglesxp table into the jinglesHistory table, removing duplicates. The MERGE is necessary to preserve the history in the jinglesHistory table. This is an example of the process:
1. First create a new history table:
   a. copy the entire existing jinglesxp into newJinglesHistory
   b. find out what entries are in the old JinglesHistory that are NOT in jinglesxp and ADD them into newJinglesHistory. So now we have a history table with all the analytics correct. We can rename it to jinglesHistory.
2. Now you can expand the jingles table to overwrite jinglesxp. So we then call CopyAnalytics (remember though if the jingle is NEW to the jingles table, there may not be analytics to copy because it won't appear in the history table).
3. CopyAnalytics—looks at the jinglesHistory to see if any of it matches the new jinglesxp entries. If there is a match, copies the analytics into the newJinglesXp

When the consumer selects ‘see jingles’, the mobile app sends a list of pois that the consumer has bookmarked. So, for example, if the consumer has bookmarked the following pois:

559 McDonalds 1 elm st

335 Abercrombe 3 main st

555 Acme 44 oak st.

and then selects the JINGLES button—the app will call fetchJinglesxpForPoiList which has the following signature:

fetchJinglesxpForPoiList(list of pois,limit)

This is the actual call:

fetchJinglesxpForPoiList(array(559,335,555),32)

Now it becomes relatively easy to search the jinglesxp table and return all of the rows that match any of the pois in the array parameter. To limit the results, such as to 32, only those jingles with the freshest delivery dates may be shown up to the limit. In addition to returning the rows, the above function may call the update the lastViewed and viewCount fields of the rows that are returned, because these jingle links will now be visible to the consumer.

Considering the above example, the rows returned from the jinglexp table will be rows 0, 4, 5, and 7. They are displayed to the consumer as links in a page as follows:

<a href=displayJingleAndIncrementClickThrough&jinglexpId=
0&poiId=555> 2 For 1 Special
<a>
<a href= displayJingleAndIncrementClickThrough&jinglexpId=
4&poiId=559> Free Shake!
<a>
<a href= displayJingleAndIncrementClickThrough&jinglexpId=
5&poiId=555> Kids Eat Free
<a>
<a href= displayJingleAndIncrementClickThrough&jinglexpId=
7&poiId=555> 20 % off pizza
<a>

In embodiments, there may be a function
displayJingleAndIncrementClickThrough

that does the following:
increments the jingle click-through count in the jinglexp table for the row whose id matches the jinglexpId
saves the poiId to the session state (for future use in Grabs—see subsequent section for description)
redirects the consumer to the jingle webpage.

Ads may be implemented in an almost identical way. However, with an additional piece of information placed in the adsxp table—the latitude/longitude of the poi. This may make it easy for the

fetchAdsxpWithinRadius(latitude,longitude,radius,limit)

function to isolate only those ads within the proper radius of the consumers location.

### Initiating the API Call:

Previously we defined the technical means in which Jingles and Ads are distributed to the consumer. We said it is done through a call to one of the api searchFunctions. However, now we will describe an example of how the consumer initiates one of those api calls.

An Ad is a mobile web page. An owner may create a webpage then tag it as using the Ad tagobject. To view the Ads, the consumer running the mobile application may select a button which will geoposition the consumer and then initiate an api request to

fetchAdsxpWithinRadius(latitude,longitude,radius,limit)

to display a list of links to mobile web pages. Each link in the list may display a “teaser” to the consumer, to encourage them to click through the link and see the Ad.

### Initiating an API Call to See Surveys:

A survey may be a mobile web page. An owner may create a webpage (e.g. should have survey questions and answers on it) then tag it as using the Survey tagobject. The mobile application may provide a SURVEY button that is associated with the specific poi that the consumer is looking at. The consumer may select the button to see a survey that is either directly attached to that poi or indirectly attached to that poi by being attached to a group.

### Initiating an API Call to see Jingles:

Before we describe how the consumer may view Jingles we first need to describe what a Jingle may be used for. A Jingle may be considered an enhancement to the traditional techniques of email marketing and opt-in texting. Opt-in e-mail is a term used when someone is given the option to receive “bulk” e-mail, that is, e-mail that is sent to many people at the same time. Typically, this is some sort of mailing list, newsletter, or advertising. Obtaining permission before sending e-mail is critical because without it, the e-mail is Unsolicited Bulk Email, better known as spam. Opt-in texting is a similar concept, except the consumer texts to a short code to opt in to a program, then receives texts (limited amount) to inform them of program offers.

In embodiments, there may be limitations to traditional opt-in techniques, such as for email. For instance, sometimes there is a direct and obvious path to opting in to an email program. The consumer will click on a “subscribe” button and know they will be receiving offers. However more often than not the consumer is unaware that they have opted in because they either didn't read the fine print or they were required to click a button to opt-out rather than click a button to opt-in. Even if a consumer has knowingly opted in, e-mail is a poor distribution method to get a message to the consumer. A consumer is ordinarily overwhelmed by the quantity of messages in their e-mail and only has time to view critical items or items from family and friends. Commercial messages are often deleted or redirected to junk. Even if the consumer is interested, by the time they actually visit the business the e-mail is left sitting on the computer at home with the consumer having vague memory that the business sent them something awhile ago. Printing the offer to hard copy is time-consuming and many consumers don't make the effort or forget the hard copy at home. Also, e-mail provides no means to organize the messages according to the business that sent them. The consumer is left to create their own folders and name them and save the messages to those folders but then this data is not accessible when the consumer is on the road.

In embodiments, there may be limitations to traditional opt-in techniques, such as in text messaging. For instance, text messages are an interruption to a person's daily life there a welcome interruption when they are coming from family friends or work however commercial interruptions are ordinarily an irritant. Text messages cannot be organized according to the business that sent them. Text messages are costly both for the consumer end for the business sending them. Text messages are limited in the number that can be sent per month. Text messages are limited in the display. Although MMS allows more graphical messages it is nowhere near the capability of a standard webpage. Most importantly does not have the ability to redirect the consumer to other offers and adds the way that normal linking does in a webpage.

Jingles provide a solution to the problems of e-mail and text opt-in. In embodiments, the mobile application displays to the consumer pois that are geographically nearby them according to any filter the consumer chooses. When a consumer selects a poi they are then able to “bookmark” that poi. However this is not the ordinary bookmark that is familiar in standard browser technology. When a consumer bookmarks a website using a standard browser application, they are simply saving the url of that site for future reference. However when a person bookmarks a poi using the mobile application they are actually opting-in to the marketing program of the business that has claimed that poi. That business may now be free to send the consumer content which can either be standard mobile webpages or enhanced mobile webpages with retail functionality such as coupons, loyalty cards, gift cards, tickets, flyers, and the like. That content may be automatically organized in the mobile application database and available for the consumer to view when they choose, and in particular, when the consumer is visiting that location. A consumer may bookmark their favorite businesses, then when they visit a business they can look at their mobile phone and see the Jingles that were sent them over the last few months. No more forgetting the paper coupon at home or trying to remember the e-mail offer that was sent you or plying through 1000's of texts you received over the last six months. Also, no more unwanted interruptions via text or email. The “opt-in” is implemented using Jingle tagobjects and Jingle searchFunction. In summary, the business creates the content then tags it as a Jingle, and in the process of tagging attaches the Jingle to the Claimed pois hierarchy.

In embodiments, the consumer running the mobile application may select the BOOKMARK button for a poi that they are interested in. The consumer, by selecting a button in the mobile application may initiate an api request, such as to either

fetchJinglesxpForPoiList(poi_ids[ ],limit) or

fetchJinglesxpForFranchiseList(franchise_ids[ ],limit).

Which may display an HTML page full of Jingle links.

### Retail Functionality

Widgets: Millions of websites such as online news, blogs, e-commerce, banks, webmail, social networking and more utilize third-party hosted content on their webpages in the form of JavaScript, Adobe Flash, Microsoft Silverlight, HTML IFrames, and images. Often referred to as Web Widgets, common examples are banners (Google AdSense), search boxes (Yahoo), traffic counters (StatCounter), games (Pogo), videos (YouTube), Twitter/RSS feeds, user polls, security badges (VeriSign Secured Seal), social buttons (Facebook Like), etc. Tens of thousands currently exist for Web developers to choose from include Digg widget, Facebook Sharer, Google analytics, BuySellAds, ValueClick, Quantcast, Collective Media, Glam Media. Third-party widgets are used on websites to embed the third party content or functionality. To avoid cross-domain security restraints they are implemented as dynamic JavaScript. The third-party widget is placed on a single page of the navigable website and either is a display seen by individuals visiting that page like Pogo, YouTube, Twitter, Facebook etc. or is a hidden analytical widget for gathering statistic on how the page is viewed (Google analytics, StatCounter, Quantcast, Bango etc). The widget can be customized before it is placed. However, traditionally, these widgets are not in any way related to the content of the page they are placed on.

In embodiments, a widgets may insert retail functionality into a web page, which is directly related to the content of the page, where retail functionality may provide the ability for a consumer to redeem an item at the businesses location by transferring the UPC or other type of identifying code into the point of sale system, limiting the use of the item by the consumer, tracking the views of the item and if the consumer saved the item, and the like. As described herein, you may use an item manager to create an item by inputting the url of a webpage into the system for the purpose of tagging it. Whenever an item is created by the item manager a widget may also be generated. The owner may pick and chooses what retail functionality they want in the widget. The owner may then be provided with an HTML code fragment that represents the widget and copy and paste that into the mobile webpage pointed to by the url of the item. In embodiments, a webpage with an embedded widget may be referred to as a “retail webpage” and the actual widget code as the “widget”. A widget may register itself to the web application so that there becomes a known relationship between the widget and the url that the widget resides in, allow a business to add interactive retail functionality to a normal web page that displays the visual content of the retail item, and the like. This may establish a strong relationship between the visual content of the page and the functionality of the widget.

Registration Functionality of the Widget: When an owner is creating items in the item manager the owner may be asked for the url address of the item and is also asked to choose different types of retail functionality to apply to the webpage pointed to by the url. A widget is generated and the owner may be required to copy and paste the widget into the webpage. What if they correctly place the widget code in web page, however, they make a mistake entering the actual url address? In embodiments, this is not an issue, because the first time that retail page is viewed by a browser, the widget may register itself to the web application in order to fill in the actual url of the widget. If this conflicts with the url address present an error may be flagged to the owner. There may be no need to even ask the owners to enter the url in the item manager, where the widget may register itself. This may be preferable to directly asking the owners to specify which url this widget will reside in at the time that the widget is created. The reason it may be preferable, is that there may be potential that a mistake could be made if the owner copies and pastes the HTML code fragment into a different url than the one they specified. So instead of asking the owners what url they are placing the widget in, the widget may just register itself.

Retail Functionality of the Widget: An owner may create a webpage (e.g. HTML) that represents a retail item, such as a coupon, loyalty card, gift card, ticket, flyer, and the like. Then the item manager may be used which creates a widget to add retail functionality to the webpage. The owner may be asked to select and specify various retail functionality that the owner wants their item to have such as the UPC code of the item, usage limits, teaser, valid dates of use, and so on. After the widget is created the owner may be presented with an HTML code fragment that they are required to place inside of the mobile webpage that visually represents the item. When the widget executes on the page, it may communicate with the web application to keep track of the item information, present UPC codes only when the item is redeemed, limit the use, provide incentive visit control such as “Receive 1 cup of coffee after buy 10”, and the like. This widget may effectively separate the display of the item from the control. The business is responsible for creating the display using known standard implementation HTML/Javascript/CSS, whereas the web application may be used to create and manage the functional control of the webpage via the widget. The business may be able to use all of the strength and flexibility of HTML including its graphical display, navigation, security, redirection, session capabilities, and the like, while additionally embedding a retail application inside of it. This is a very different path from typical “couponing” applications, like Yowza, which force the owner to use a proprietary “coupon” template (not HTML based), which has limited display capabilities and cannot be distributed using standard browser technology.

As discussed herein, the item manager may be used to define the url, teaser, and retail functionality of the webpage. The item may be a webpage with a teaser as metadata. In embodiments, in the item manager the owner may be asked to input information, such as:
Is Message—if this webpage is just a flyer with no upc control, then this field may be set true and all the remaining fields set to null;
Start Date—when the item is valid;
End Date—when the item is no longer valid;
Is Dynamic—this may allow the owner to have an item that is delivered with a unique UPC code for each consumer. This is especially valuable to track items, and may be necessary for loyalty and gift cards;
UpcCode—the owner inputs the UpcCode of the item, and the platform supports all the major upc code types including text and semacodes. Note, if this item Is Dynamic than the owner may not have to enter an UpcCode here, because the UpcCode may be dynamically generated; and the like.

In embodiments, the next fields may support dynamic upc codes. The owner may be able to enter the beginning and end of a series of upc codes that they want to be delivered to the consumer. The series may need to be integer and the Series End to be greater than the ‘Series Start’. When a consumer views an item that ‘Is Dynamic’, they may be seeing the next dynamic upc code that is available because the application may automatically deliver the next upc code in the series. This may be a very powerful feature because the owner may use their in-house loyalty or gift card system without modification. They may be able to take a series of available upc codes and enter them into the ‘Series Start’ and ‘Series End’. The mobile item may effectively replace plastic cards.

In embodiments, the ‘Refill Series Start’ and ‘Refill Series End’ may provide the owner the ability to refill a series if it starts to get low. When series start gets close to series end the owner may be informed via e-mail and told that they are almost out of the item. If they choose they may enter a new series into Refill Series Start and Refill Series End. When the original series is empty it may switch over to the refill series, including Series Start, Series End, Refill Series Start, Refill Series End, and the like.

In embodiments, ‘Is Interactive’ may provide redemption of the item, and may be a very important part of the platform. An item may be redeemed visually by inspection of the cashier at the business location. Alternately, the owner may be able to specify that an item be delivered at the point-of-sale (pos), directly into the pos software (e.g. cash register) using the Bluetooth, WiFi, and the like capabilities of the mobile device. Again, there may be no need for visual inspection by the cashier, instead the item information may be directly delivered into the pos software. The ‘Is Interactive’ field may determine if this is a capability of this item, such as for Limit Per Customer (e.g. the owner can limit the number of uses of this item), Number of Visits (e.g. the owner can make the item and incentive card, such as ‘buy 10 cups of coffee and get one free), and the like. After completion, the margin may be given in HTML code fragment to insert into the webpage. The code fragment may represent dynamic JavaScript that is used to communicate with the server from a third party cross domain webpage. It is the owner's responsibility to place the code fragment in the webpage.

Example of How a Widget Works: Once the webpage is created and the widget embedded in it, the webpage may be referred to as a retail webpage. As described herein, an item (which may represent either a normal webpage or a retail webpage) may be distributed to the consumer as a Jingle, an Ad, and the like. This is one way a retail webpage can be seen. In embodiments, there may be another feature of the platform that also lets an item (which may represent either as normal webpage or a retail webpage) to be distributed to the consumer as a reward for filling out a survey, as described herein. This is another way a retail webpage can be seen. Finally, since the retail webpage is a web page, it may also be placed as a page anywhere in the owners website. There may be no requirement to make it a Jingle, an Ad, Survey Reward, and the like.

In embodiments, there may be multiple ways in which a retail webpage can be presented to the consumer. The entire purpose of the retail webpage is to provide the “retail functionality” as described herein, including redemption, limiting use, tracking access, and the like. So, what happens when it is viewed?

In embodiments, the embedded widget in the retail webpage may be dynamic JavaScript executed on the load of the page. The widget may perform a plurality of functions, such as accessing the retail information from the server, such as LIMIT PER CUSTOMER, IS DYNAMIC, UPC CODE, and the like. Based on the retail information it may identify if the consumer has already redeemed it or not, and how many times they have redeemed it. All history of redeemed retail webpages and the consumers who have redeemed them may be kept as data in the server. Consumers may be identified by a login that may be executed at the time they open the mobile application. In embodiments, the first time the mobile application is opened, the consumer may be forced to register. If the retail webpage IS DYNAMIC the server may assign it a new UPC code, or if the UPC code for the retail webpage has run out, the consumer may be informed. If the consumer has not redeemed then a REDEEM button may be displayed on the retail webpage. If the consumer has reached their limit, a message may tell them so. If the consumer selects the REDEEM button, the UPC code may be displayed. At that time the owner may have several options, including having the cashier manually view the UPC (or other identifying) code and enter it into the point of sale system; using the downloaded BinPOS Register application, the cashier may allow the consumer to transfer the UPC (or other identifying) code into the point of sale system wirelessly using Bluetooth, Wifi, and the like. The retail webpage may be a powerful tool for a owner to use, where they may effectively use existing marketing campaigns, including existing web designs, and upc codes, and simply distribute them to the consumer without taking on the burden of developing a mobile application to handle all of the redemption functionality.

Pseudo-Code that Represents the Widget

The owner may need to place the script widget at the bottom of their page and place the header division at the top (e.g. so the user doesn't have to scroll to see the redemption and grab buttons). After the owner page loads, the widget may be loaded and runs a server side php script providing several passes.

First Pass: In embodiments, a first pass may validate the item and franchise match. If not, a same-domain hidden iframe with itemId set to 0 may be loaded to tell application that this item is corrupted. The point of the hidden iframe in this case, may, if the user selects grab button, may be able to access a function in the iframe that will return the itemId, and then know that the webpage is actually a retail webpage and that the page is corrupted and therefore do not call the jsGrabItem, and also give an alert to the user that the grab can't take place. Without the iframe, the application may think it's a normal url and go ahead and grab it as an unknown item. Note that if consumer is not running the application, the hidden iframe may still be there but will never be accessed. This may be fine because if the item is corrupted, the grab button may never appear, and there may be no way to grab. If validated, the it may call the function:
(_displayButtonsOrLoginHTMLDependingOnDynamicAndLimit—which may return html that either places the proper buttons in the header div
(_htmlForButtons) or places the login form in the div (_htmlForLoginUser),
   and fetch the item data to flow through the page. It may also call

fetchUpcCodeToFlowThroughPage

to get the dynamic upc code, which may come back:

unknown because consumer is not yet logged in,

unassigned because consumer never grabbed it,

valid upc code because consumer previously grabbed it, and the like

and assigned to $upcCode in the php code. In an example, the following JavaScript may be written to the page:

hidden iframe with itemId

lazyload code to load our scripts (Jquery and binja.js)

after lazyload—
pushes html from
_chooseButtonsOrLoginHTMLDependingOnDynamicAndLimit into the widget div—so now you either have buttons or login form
pushes item data into the <spans> for flow through. (What this means is that the business owner may put “placeholders” in the webpage in the form of <span> tags such as:
<br> The item Start date is <span id=“binjaStartDate”></span>
So “pushing” the item data into the spans means that the php script will return javascript that uses document.getElementById to find the binjaStartDate item and update the innerHTML of the span.) pushes $upcCode into the <spans> (could be unknown, unassigned or valid) for flow through.
   As a note about placeholders, if authorization is not complete the dynamic upc code may not be pushed into the page so it is set to “Unknown”. Then after LOGIN PASS it may return to the FIRST PASS which may show “Not Assigned”, the actual dynamic upc code if it had previously been grabbed, and the like. Then in FINAL PASS after the user selects the redemption or grab button, the dynamic upc code may have been assigned and is pushed into the page (even if it was previously displayed in the page as a valid dynamic upc code, it may be pushed in again in the redeemed function, just to cover the case that it hadn't previously been assigned).

LOGIN Pass: In embodiments, a login pass may, after the entire page is loaded, involve the user typing in their password. This may include multiple back and forth until password is correct. Once this completes, the process may return to FIRST PASS, which may then display the correct dynamic upc code, not assigned, and the like.

FINAL Pass: In embodiments, a final pass may involve the user selecting a redemption button. Up until now the upcCodeImage may not have been displayed, but now it may, which may be true regardless of whether its static no limit, static limit, dynamic no limit, dynamic limit, and the like. Also, it may flow through the dynamic upc code which may have already been correct or may have been “Not yet assigned”. Finally, the button name may be changed to “Redeemed”. The following is an example:

displayButtonsOrLoginHTMLDependingOnDynamicAndLimit

1. If not authorized . . . show login form and return

2. if NOT dynamic then call function
decorateRedeemButtonDependingOnLimit which does the following
   i. if no limit output link that says Click No Limit To Redeem whose href=jsRedeem. If the user clicks on the link then the jsRedeem server php script will run.
      else call function canRedeem which determines if the user has reached their limit or not. If they have not then output link that says Click to Redeem whose href=jsRedeem
   ii. then output link that says ReachedYourLimit whose href=#(meaning the user cannot click)

else if dynamic then see if consumer already has code.
a. If !fetchGrabItem && hasDyanmicUpcRunout then consumer doesn't already have this item (with assigned code) and its runout so output link that says Sorry this item has runout whose href=#
b. decorateRedeemButtonDependingOnLimit
   as above
      This may happen on the SECOND PASS:
      If user clicks on Redeem then php script jsRedeem is called
grabItemAndBookmarkPoi is called which will only return false if the item ran out, otherwise _grabItemANdBookmarkPoi we'll do all the work of seeing if the item was already grabbed/bookmarked, and if not, grabbing and bookmarking, possibly assigning dynamic is necessary and alerting the user as to what happened.
if grabItemAndBookmarkPoi returns true then _redeem it is called to:
   change text on redeem button to “Redeemed”
   write an img tab to display upc
   regardless of whether or not its an unlimited item, increment the redemption count (should be OK to do!)

### Tracking

The combination Claimed pois hierarchy, expansion, and tagobjects creates a very sophisticated analysis of views and click-throughs that is geographically based. The business owner may be able to view the tracking data by individual poi or by group. This additional tracking information may not be available in products like Google Analytics. Tracking capabilities are now described, and although the disclosure refers specifically to Ads and Jingles, the concept can be extended to any type of tagobject. In embodiments, tracking tracks the number of times an Ad link or Jingle link has been viewed and the poi (e.g. business address) associated with that view. The number of times an Ad link or Jingle link has been clicked-through may also be tracked to show the actual webpage of the of Ad or Jingle. Here is an example: Lets say, that the ad mentioned, was created by the business owner and attached to the entire Regina's franchise group. Meaning, that any consumer within the vicinity of any Regina's location will see the same ad. If a consumer is standing near a Regina's Pizza at 1 Elm St. and they select the OFFERS button, they will see a list of ad links, and one will be for Reginas, lets say with ad id=35. That will increment the “ad link view count” of that ad, but specifically, for that location Regina's at 1 Elm St. If the user drives across town and again selects the OFFERS button, they will see a list of ad links, and see the same one, with ad id=35, for Reginas. That will increment the “ad link view count” of that ad, but specifically, for that location Regina's at 20 Washington St. Furthermore, if the consumer clicks through to see the ad webpage, that will increment the “ad link click-through” count, specifically for that location at 20 Washington St.

In embodiments, the number of times a retail webpage has been GRABBED and the number of times it has been viewed is tracked. This is an entirely new concept in tracking methodology. The business owner can now see a different level of interest from the consumer, the consumer is not just looking at the webpage but is saving it for later use. The system also may track the number of items a retail webpage is redeemed, the number of times a retail webpage has been viewed, and the like.

### The Mobile Application

The following are embodiments of features and functions of the mobile application, as also discussed herein, and are not intended to be limiting in any way.

Select Nearby Businesses: The consumer's geo-position may be sent to a server and a list of nearby businesses displayed. The consumer may be able to filter the search, such as based on radius, name of business, type of business, general search phrase, and the like. Once the list of businesses is presented to the consumer, a single business may be selected and information about that business, such as name, address, phone, credit cards accepted, and the like may be displayed in addition to other options as described herein.

View a Business's Website: The consumer may select the link and navigate in the traditional manner to view webpages. The website may or may not be a mobile website depending on what the business has implemented.

Bookmark a Business: By bookmarking the business the consumer has basically “opted-in”. For instance, the business may then send the consumer Jingles and the consumer can choose to view a Jingle at their convenience. The application may optionally audibly “jingle” the user to tell them new Jingles are available. The consumer may also optionally request to be texted when new Jingles are available.

View Jingles of a Bookmarked Business: When the consumer requests to see Jingles, the application may use a API to call a Jingle searchFunction which will display a list of Jingle links. Each link in the list may display a “teaser” to the consumer, to encourage them to click through the link and see the Jingle.

View Ads from Many Nearby Businesses: When the consumer requests to see Offers, the application may geoposition the consumer and via a API call the Ad searchFunction to display a list of Ad links. Each link in the list may display a “teaser” to the consumer, to encourage them to click through the link and see the Ad.

Surveys and Review: Most local search applications encourage users to write a review for a business so that opinions can be shared with other users. In a mobile environment this is a time-consuming and difficult task. The screen size and keyboard are not conducive to easily writing an opinion. Of course, the user is able to rate the business without writing an opinion but this is limited information to another user. Reading these reviews is also time-consuming for the consumer who wants to see opinions. Many times the reviews are wordy and rambling. While this may be acceptable when browsing from your home computer, it is less so when you're on the go using a mobile phone with a small screen. An alternative to state-of-art reviews are mobile surveys and “tweet”-style reviews.

A survey is a way of letting the mobile consumer tell a business owner how they feel about their business. The mobile consumer doesn't have to type their opinion as a review, instead they just use checkbox's to identify how happy they were with their visit. All consumer businesses are categorized into categories, such as 2-300 categories. There is a generic survey written for each category of business. Using this innovation, no matter what business a consumer visits, there may be a survey they can fill out. Surveys are a replacement for the review functionality of most local search applications.

In embodiments, the survey may be delivered as generic, custom, and the like. The generic survey is written with questions based on the category that the business is in. Although these questions aren't specific to the exact business at a location, most of the questions are extremely relevant to that business type. Any business can use the web application to write their own custom survey that will be presented to consumers who are near their business. The custom survey will replace the generic survey. The reason the generic survey exists is because initially, most businesses will not be signed up to use the platform, however, the web application may still aggregate information on the quality of the business service or products from consumers who fill out the survey. This is much more organized and specific information than reviews and is extremely beneficial to the business owner. This also encourages a business to sign up to use the platform. Through surveys, we may be providing them key information on their products and services without the usual negatives and scurrilous comments that can be made by reviewers.

The web application limits the type and number of questions in a survey to make them more convenient for consumers to fill out. As stated herein, the Survey tagobject/searchFunctions are used to tag Surveys and deliver the proper one to the consumer. The owner may write more than one survey and attach them at different levels of the claimed poi groupings. For instance, a business might want a specific type of survey for the grand opening of a new location and so attaches the survey to a specific poi. However, they might also want a different survey for their other locations and would thus attach that survey to the entire franchise group. The survey tagobject/searchFunctions may take care of determining which survey to send. Since there may be a survey for the specific poi, it will take precedence over the surveys for the entire franchise group.

The web application may aggregate survey results and present them to the business owner in tabular format. This is a way to get immediate marketing feedback from consumers, it is both flexible and very powerful in that result data can be seen as it relates to the Claimed pois hierarchy.

In embodiments, the business owner may deliver a reward to consumers who complete the survey. For instance, the reward may be in the form of a retail webpage. The retail webpage may represent a coupon, free tickets, or some other monetary compensation for filling out the survey. Combinations of targeting surveys via the claimed pois hierarchy, plus using retail webpages as rewards may make surveys a powerful tool for the business owner.

Mobile consumers may be much more likely to fill out a survey then to write a review. Most consumers may be adverse to writing their opinion, but still want their views to be known. A survey is the perfect vehicle for on-the-go mobile users, where they can get and give opinion data efficiently. The consumer may also choose to see survey results. This is an alternative to seeing reviews. The data is more specific and concise, and may allow the consumer to see options of a large statistical sample, unlike reviews which can skew the reputation of the business.

Surveys may be written in sections, so the mobile user can fill out only the sections they are interested in. This attempts to make the process more efficient, thus engaging more customers. Section types may include general, service, facility, and the like. For instance, for general they may fill out a survey that discusses the overall characteristics of the business. For service, they may fill out a survey that discusses the service they received. And for facilities, they may fill out a survey on the facilities of the business.

In embodiments, surveys may be used as generic surveys to aggregate data before the owner has signed up; customized surveys attached to various levels of the Claimed pois hierarchy (e.g. allowing a owner to survey differently at one store than another, or survey differently at one region or at another); sectional surveys to allow less input from consumer, thus engaging more consumers; ability to distribute retail webpage reward to consumer upon filling out the survey; use of graphical emoticons to further engage the consumer and make the survey entry fun; reporting of survey results to allow the consumer to see options of a large statistical sample matched to the hierarchical structure of the claimed pois hierarchy; and the like.

In embodiments, a consumer may write a review, such as a short review (e.g. limited to less than 140 characters). When the consumer sees review results, many reviews may be visible in the small mobile screen size, such as because of a character limit.

### Grab a Webpage

The mobile application provides a GRAB function, such as with a grab button, to allow the consumer to capture a webpage or retail webpage that is displayed to them. The mobile application may present web pages to the consumer, such as by viewing the business's website, viewing a Jingle sent by the business, viewing an Ad sent by the business, viewing a Survey sent by the business, and the like. The webpages discussed herein may allow linking so the actual number of webpages the consumer can see may be unlimited. The GRAB feature may allow the consumer to save any webpage to a folder named after the business that it came from. At a later date, the consumer may easily navigate to that business and see all of the webpages that were grabbed. For instance, if they grabbed a retail webpage, they can then redeem it at a later date. Note to clarify and avoid confusion, as discussed herein, the application term “Bookmark” means to save a business and create a channel to it. The term “Grab” means to capture a webpage url and save it in your database, categorizing it under the name of the business that created it. In implementation, the ‘Grab’ may be similar to the traditional browser ‘bookmark’ except it intelligently adds the relationship of the business it came from.

The mobile application may be an application that delivers webpages to the consumer in a constrained environment. Although it has an embedded browser, it may not allow the flexibility of the typical browser in which the user can specify any address and browse to any location. Instead, the consumer is delivered webpages from the various brick-and-mortar stores in the nearby vicinity. The consumer may view the website of the store, or may receive directed webpages from the owner in the form of Jingles and Ads. By limiting the webpages the consumer can see, the application may be able to intelligently determine what webpages are from what business. This may allow the application to store GRABBED pages in the proper location in the directory structure, in association with the business name that the webpage was sourced from. In embodiments, when a user GRABS a webpage they may be asked if they want to save it under the name of the business that the mobile application thinks it belongs to or if they would like to choose a different business or even save the page in a folder name of their own choosing.

### The Mobile Application Database

The mobile application database may be described as a file system that looks like a snapshot of a consumer's life. There may be a folder for all the major consumer categories in a typical persons life, such as shopping, schools, restaurants, entertainment, nightlife, etc. The database may categorize all of the users bookmarked pois underneath these category folders. When they select a category, for example, “Restaurants” they will see all of the business's they have bookmarked in the “Restaurant” category, and then underneath those businesses the bookmarked business, they will see any of the webpages they have GRABBED. If the consumer bookmarks a single business within a franchise, that business may be displayed with its name and address to the consumer, underneath the folder that matches the category of the business such as “restaurants”. As an example, the user bookmarks their favorite pizza place, Regina's Pizza. In the database, the consumer can select the “Restaurants” icon, and the following will be displayed: Regina's Pizza 22 Elm St, Boston. If however the user bookmarks more than one Regina's pizza in the Regina pizza franchise, then the database is smart enough to display only the franchise name with an arrow to allow the consumer to see the various locations in the franchise they have bookmarked, such as: Regina's Pizza>>. Basically, the database is aware of the structure of the Claimed pois hierarchy, as described herein. Also, the database may supports other kinds of sorting, such as alphabetical, by category, by location, etc. The database may display the webpages that the consumer has GRABBED. If these are normal webpages there may be little additional information that can be displayed about the GRAB other than the date it was grabbed. However if the consumer grabbed the retail webpage, then all the information contained in the widget may be used to inform the consumer of the status of the retail webpage. For example, a status that may be given to the consumer may include how many times they have redeemed the page, how many redemptions are left, if the page is void because of invalid dates, if the page is void because they have reached their limit, and the like.

Use of Retail Webpages without the Mobile Application

As described herein, the concept of GRABBING has been presented as a button in the mobile application that the consumer selects when they want to save a webpage or a retail webpage to their mobile application database. However, what happens if the consumer stumbles across a retail webpage and is not using the mobile application? Remember, a retail webpage is simply a webpage with the capability for redemption, and the business owner is free to place it anywhere in their website. The server that the mobile application communicates with may be able to intelligently determine if a retail webpage is being viewed from within the mobile application or from within another browser application. If not in the mobile application, the retail webpage may automatically display a grab button embedded in the page. This is an innovative feature in that it now opens up the functionality and display of retail webpages to all consumers regardless of the mobile device (e.g. mobile phone) they have, and regardless of whether they have the mobile application. A retail webpage may then be distributed by any application.

In embodiments, the GRAB button may only be displayed on the retail webpage if the consumer is not using the mobile application and is viewing the retail webpage using some other browser application. This begs the question as to why the GRAB button isn't always visible on retail webpages even when the consumer is using the mobile application. The reason is that in the mobile application, the consumer may GRAB any type of webpage displayed in the application browser. Both retail webpages and normal webpages. If we displayed the GRAB button embedded in the retail webpage, we would still need a button in the application to GRAB normal webpages. It would be confusing to have the GRAB button in both locations, so when inside the mobile application the GRAB button may be displayed in the toolbar of the application. In embodiments, The GRAB button may be presented using the dynamic JavaScript of the widget. If the GRAB button is selected the consumer may be asked to login or register with the mobile application (e.g. the web version of it), before the GRAB can take place.

### Flow-Through Feature of the Retail Webpage

In embodiments, since the business owner may embed the widget into their webpage they might like to be able to access the information of the widget, where the widget may contain information such as start date, end date, ‘is dynamic’, upc code, series start, series end, refill series start, refill series end, ‘is interactive’, limit per customer, number of visits, and the like. The system may allow the business owner to put a “placeholder” manually into the display of the page. This placeholder may be filled in with the values specified in the widget. This begs the question—why would the business owner need to do this when they are the ones who filled in the widget in the first place? Although the business owner knows what these values are, certain values like the dynamic upc code are not known until runtime. Using a placeholder, the business owner may be able to access this information and present it to the consumer in the display portion of the retail webpage at runtime. As an example, the business owner could place a link in the display, including a placeholder to the dynamic upc code, which would allow the consumer to go to a specific webpage related to that dynamic upc code. By including the dynamic code in a link to the consumer could be redirected to a loyalty page that shows all of their specific loyalty points. Other values could be used for display also. For example, instead of directly entering the start and end dates into the display of the page, the business owner could instead put a placeholder in the page, and then the Start Date and End Dates specified when the widget is created automatically be filled in to the placeholders. If the dates change, so will the display of the page.

### Instantly Connect User to Current Location

The mobile application may provide a “nearby” feature in which the consumers geo-position is sent to the system server and a list of nearby business's is displayed. The consumer may be able to filter the search based on radius, name of business, type of business, general search phrase, and the like. In embodiments, the mobile application may also able to show all business's nearby with out any filter, providing this capability because the goal may be to immediately connect the individual into the user's current location. As the individual moves in position, the business they are closest to may “float to the top” of the display.

### People as Points of Interest

In embodiments, the present invention may be applied to any geographical location within the vicinity of the consumer. For example, a historic monument or a bridge, mountain pass, etc. may be considered ‘businesses’ in that they may be identified in terms of a geographical location. For instance, a town may “claim” a historic monument and “jingle” the consumer with information about the monument, possibly sent a coupon to visit a related museum or information about another town event. Anything that has geographic presence may be considered a ‘business” with respect to this document.

In embodiments, this concept may allow an individual to be a “poi”. The individual has geographic presence if they are running the application on their mobile device. The individual may also have a “website”, which is their personal website or Facebook page. The difference between an individual as a “poi” and a store is that the individual's position is dynamic, plus the individual is not listed in the yellow page directory and therefore may not be “claimed”. However, these problems may be solved by allowing an individual to “register” themselves as a “poi” which is an automatic way to “claim” their listing. They may then able to update various information including their website. Another individual running the Application may select the Nearby button and specify if they want Nearby “fixed” locations (meaning stores) or Nearby “dynamic” locations (meaning individuals) or both. In this manner one can use the system to connect to other individuals to see surface information on the person. Note this is not a tracking mechanism such as Loopt, or Helios Buddy Beacon, and the like. This is a “presence” feature, meaning “if” an individual near you has allowed themselves to be seen, then they will appear on the Nearby list as a “poi”. Of course, that individual doesn't interface to the web application, they instead use the mobile application to create and receive dynamic messages (texts) to other users of the mobile application. This allows anonymity, in that the individual does not have to release their phone number to send/receive messages. Having an individual as a poi may also allow a consumer to share content they have GRABBED with the individual.

### Keyboard Wedge

As discussed herein, in the retail webpage the consumer may select a REDEEM button, where the UPC code may then be displayed. At that time the owner may have different options, including having the cashier manually view the UPC (or other identifying) code and enter it into the point of sale system; using a downloaded BinPOS Register application, the cashier can allow the consumer to transfer the UPC (or other identifying) code into the point of sale system wirelessly using Bluetooth, WiFi; and the like. In embodiments, the consumer may wirelessly transfer upc (or other identifying) information into the point of sale, avoiding the possibility for error inherent in making a cashier enter the information manually.

The term “Keyboard Wedge” when used in reference to retail point of sale peripherals means that the point of sale hardware peripheral such as a magnetic stripe reader, is connected to the point of sale system through a keyboard port. The point of sale system sees the peripheral as just keyboard strokes and this is a standard way that hardware peripherals like magnetic stripe readers are able to enter the UPC codes of plastic cards into the point of sale software. The mobile application may enable a consumer to wirelessly redeem a retail webpage, such as when the BinPOS Register Application is loaded onto the point of sale system. The BinPOS Register Application communicates with the mobile application via wifi, Bluetooth, and the like. The mobile application may transfer the UPC information from the mobile phone to the BinPOS Register Application wirelessly as described herein. The BinPOS Register Application emulates a magnetic stripe peripheral by making the information it received from the mobile device (e.g. mobile phone, and the like), seem like keyboard input to the point of sale register. It does this by using the sendkeys function calls that are part of the OS of the point of sale system. The mobile application may emulate the plastic card (or coupon, or ticket or any other redeemable item that is identified with a UPC like code). The communication between the phone and the BinPOS Register Application may be emulating the physical swiping of the plastic card (or the physical scanning of the coupon, ticket or any other redeemable item that is identified with a UPC like code). Then the BinPOS Register Application, sending the data to the OS as if it were actual keyboard input, may replace the physical keyboard wedge hardwired connection that many point of sale peripherals use to send data into the system as though it were being typed at the keyboard.

The BinPOS Register Application may include socket code and implemented as a server. In embodiments, the present system may use zero-config method Bonjour for Windows to register the service, although any zero-config process would also work. The BinPOS Register Application may be always running on the point of sale and it publishes itself. When multiple point of sale systems exist, as is common in many owner stores, all of the BinPOS Register Applications may publish themselves and it may be the responsibility of the consumer to select the correct system that they want their redeemable item or receipt etc. to be sent to. To make this simple, the owner may name each point of sale system so that zero configuration can identify it when the service is published. The owner may then create a visual cue so the consumer can identify the point of sale system they are standing in front of. For example, if a owner has 3 point of sale systems, they will be named in each BinPOS Register Application as either Register1, Register2, Register3. The owner will place a sign at each the register identifying it as #1, #2 or #3. When the user tries to redeem their item, they will see a the list cash registers Register 1, Register 2, Register 3 on their phone, and will select the correct one they are standing in front of.

### Wireless Redemption

In an example, when the user decides to redeem the following may take place. In this example, the term “mobile” will replace the longer phrase “mobile application”.
1. The user is viewing a retail webpage and selects the REDEEM button.
2. The mobile uses zero configuration (Bonjour) to find any BinPOS Register Applications in the vicinity. The mobile will return this list to the user. The user will select which register they want to redeem the item to. As soon as user makes the selection the following happens:
3. The mobile will send the following data to the BinPOS Register Application over the socket
   BinJaUpcTransfer—this is the code that identifies this transfer as a BinJaUpcTransfer
   consumerId—ID of the BinJa app user
   InvalidMask—if 0, the S_UPC should be wedged. If not 0, then the clerk must be notified and allowed to override the invalid item, allowing it to be entered into the system. This is in case the first time messed up, and now the item is invalid because its limited, but the clerk will accept the transfer anyway.
   S_UPC—the UPC code of the item
   S_MerchantId—the MerchantId of the item
4. The BinPOS Register Application is a server. After it publishes itself it is waiting on the socket from data from a mobile. When it receives data it does the following:
   If the operation code !=BinJaUpcTransfer set bit in InvalidMask and GOTO FAIL else continue
   Display BinJaID to clerk. They must select the user to continue. After 10 seconds, if BinJaID is not selected BinPOS will return NO_RESPONSE to mobile.
   Once the user is selected then
      1. If S_MerchantId !=BinPOS Register Application MerchantId then set bit in InvalidMask and FAIL
   sendkeys the S_UPC code to the pos software
5. return SUCCESS to mobile. GOTO END
   ASK_FOR_OVERRIDE
   Message the clerk with a description of why the upc code is invalid based on the bits set in the InvalidMask then ask if they want to override or not. If YES then goto #9. If NO then return ERROR to mobile with ERRORMASK invalid bit set. GOTO END
   ERRORMASK can tell the mobile the following:
      response timed out—this happens if clerk doesn't select you
      nvalid
      opcode was invalid or some other error in the format of the request
      ownerId didn't match
   If clerk overrides an error, do we decrement voidCount? Yes. What if void count is already zero (because the clerk overrode the case of voidCount=0). Then don't decrement it again.
6. Mobile receives either SUCCESS or ERROR with ERRORMASK. If SUCCESS then incrementRedemptionCount. If voidCount is 0 then GOTO ASK_TO_DELETE_ITEM.
7. If ERROR then inform the user and GOTO ASK_TO_DELETE_ITEM
ASK_TO_DELETE_ITEM
   1. NO—GOTO END.
   2. YES—item is deleted, GOTO END

For example, if there are 3 cash registers, the owner may need to put a sign on each that is visible to the customer that identifies the cash register as either register 1 or register 2 or register 3. When the user attempts to REDEEM their item to the cash register, the mobile application will look for the POS service and since there are 3 cash registers, then there should be 3 services found. In this instance, each service will be named with either a 1, 2, or 3 in it so that the customer can correctly select the cash register that they are using to check out.

### Other Embodiments

In embodiments, the consumer may GRAB any webpage that they see. Alternatively, there may be the ability to restrict GRABbing to only those consumers who are within a very close distance to the location. This may be to reward consumers when they are physically located at or very near the location.

In embodiments, a user may be allowed to copy mobile application phone numbers into their phone contact list. The mobile application may be a way to store information on a consumers favorite businesses. So, in some regards, it may be a contact manager. In embodiments, the system may be integrated into other contact managers.

In embodiments, the system may allow nesting of pois in a campus environment. Part of this may already be done by “franchising” a campus and specifying a different mobile website for each (although its not really a different mobile website, its different parameter passed into the mobile website so the owner may direct different info to different regions). The system may have the ability to double click on a business, and, if the owner specifies it, the poi may expand into multiple pois that represent the various buildings on the campus. For example, if the user is at a college, only a single poi for that college would show up in the nearby view even though there were, for instance, 10-20 buildings in the area for that college. Then the user might select the poi and it would expand to see all of the individual pois. This may be preferred to having one poi which opens a webpage that has a list that allows the user to go to the individual buildings like NewmanTowers, CalverHall, SchoolInfo, etc. This may aid in pinpointing a consumers position and directly connecting them into the website (or link inside a website) of the poi they are closest to.

In embodiments, the Redeem button may have a transfer button which allows user to pass the Item to another consumer, such as by transferring it directly into another phone running the mobile application, emailing it, texting it, and the like.

In embodiments, the mobile application may create a SCRAPBOOK of entity information, which may be more than tradition Photos and Video, such as POS information (e.g. coupons, maps, menus, pictures), what the user creates (e.g. photos, video stream, comments), and the like.

In embodiments, the present invention may present the consumer with a single interface to communicate to all the businesses in their life. The business owners may concentrate on attracting new customers and delivering marketing incentives. They may avoid the complexity of implementing a mobile platform for storage and redemption and then marketing that mobile platform. By using a single portal, traditional brick-and-mortar companies may harness the power of the mobile Internet to increase sales and create customer loyalty.

While the invention has been described in connection with certain preferred embodiments, other embodiments would be understood by one of ordinary skill in the art and are encompassed herein.

The methods and systems described herein may be deployed in part or in whole through a machine that executes computer software, program codes, and/or instructions on a processor. The present invention may be implemented as a method on the machine, as a system or apparatus as part of or in relation to the machine, or as a computer program product embodied in a computer readable medium executing on one or more of the machines. The processor may be part of a server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more thread. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer software on a server, client, firewall, gateway, hub, router, or other such computer and/or networking hardware. The software program may be associated with a server that may include a file server, print server, domain server, internet server, intranet server and other variants such as secondary server, host server, distributed server and the like. The server may include one or more of memories, processors, computer readable media, storage media, ports (physical and virtual), communication devices, and interfaces capable of accessing other servers, clients, machines, and devices through a wired or a wireless medium, and the like. The methods, programs or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the invention. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the invention. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, and instructions described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like. The cell network may be a GSM, GPRS, 3G, EVDO, mesh, or other networks types.

The methods, programs codes, and instructions described herein and elsewhere may be implemented on or through mobile devices. The mobile devices may include navigation devices, cell phones, mobile phones, mobile personal digital assistants, laptops, palmtops, net books, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer to peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipments, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a general purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

While the invention has been disclosed in connection with the preferred embodiments shown and described in detail, various modifications and improvements thereon will become readily apparent to those skilled in the art. Accordingly, the spirit and scope of the present invention is not to be limited by the foregoing examples, but is to be understood in the broadest sense allowable by law.

All documents referenced herein are hereby incorporated by reference.

1. A method comprising
hierarchically structuring geographic locations to attach and deliver content to individuals near the geographic locations through a web-based search facility, wherein the geographic locations have data associated with them;
storing the geographic locations with their associated data as points of interest (poi) in a poi database; and
claiming ownership of the poi by an entity associated with the poi, via an Internet web application and whereby an entry in the poi database is marked as being owned by that entity.

2. The method of claim 1, wherein the data associated with the geographic location is an object with specific fields, where there are at least one type of objects stored in the pois database.

3. The method of claim 2, wherein a type is a destination object which stores information about consumer businesses including at least one of name, address, phone number, website, latitude, longitude, credit cards accepted, and hours of operation, of geographic locations that are normally considered destinations for consumers.

4. The method of claim 3, wherein the destination is at least one of a commercial entity, government entity, historical entity, and scenic entity.

5. The method of claim 2, wherein the pois of object type destination are initially obtained from multiple third-party sources and placed in the pois database.

6. The method of claim 5, wherein the third party source is a yellow page aggregator.

7. The method of claim 1, wherein the claiming is via a web form on the Internet web application.

8. The method of claim 7, wherein once owned by an entity the poi can be owned by none other.

9. The method of claim 7, wherein the entity can hierarchically group their claimed pois.

10. The method of claim 9, wherein the groups can be any subset of the claimed pois.

11. The method of claim 9, wherein the groupings can be named for identification purposes.

12. The method of claim 9, wherein there is a default group called a franchise that includes all the claimed poi.

13. The method of claim 12, wherein the franchise grouping is at the top of the hierarchy.

14. The method of claim 7, wherein once the claimed pois hierarchy has been identified, content in the form of web pages can be attached to different groups, allowing distribution of content to consumers based on a constraint that they use in order to perform the grouping.

15. The method of claim 14, wherein the constraint is a geographic constraint.

16. The method of claim 1, wherein the poi database can be added to if the entity associated with the poi does not find their location listed in the database.

17. The method of claim 16, wherein after adding their location as a poi, the poi can then be claimed.

18. The method of claim 7, wherein the poi database can be reduced if the entity associated with the poi wishes to remove a poi that it has previously claimed from it.

19. The method of claim 1, wherein the content can be extended to at least one type of texts, email, and voicemail content.

20. The method of claim 19, wherein the content is a webpage.

21-119. (canceled)
